(19) United States
(12) Patent Application Publication
(10) Pub. No.: US 2026/0284693 A1
(43) Pub. Date: Sep. 24, 2026

(54) Liquid Applicator Sleeve and an Applicator Assembly including such a Sleeve

(71) Applicant: Sandon Global Engraving Technology Limited, Runcorn Cheshire (GB)

(72) Inventor: Gary Carmichael, Runcorn Cheshire (GB)

(73) Assignee: Sandon Global Engraving Technology Limited, Runcorn Cheshire, GB (GB)

(21) Appl. No.: 19/475,149

(22) PCT Filed: Mar. 8, 2024
(86) PCT No.: PCT/EP2024/056161

§ 371 Date: Oct. 14, 2025

(30) Foreign Application Priority Data
Apr. 17, 2023 (GB) 2305629.4
May 5, 2023 (GB) 2306638.4

(51) Int. Cl. B05C 1/08; B05C 1/02

(52) U.S. Cl. CPC B05C 1/0808; B05C 1/022; B05C 1/0813

(57) ABSTRACT

An applicator roll assembly includes a lightweight metal body having a hollow central hub portion, a peripheral axially extending flange and a radially extending web portion which extends between and unites the hub and the peripheral flange, around which is mounted a bridge mandrel. The bridge mandrel is secured to the body component exterior cylindrical surface. The bridge mandrel rear end is provided with a backstop which creates an annular abutment shoulder. Either a spacer element and then a separate polyurethane sleeve are slid over the bridge mandrel until the spacer element abuts the raised annular at the rear end of the bridge mandrel, or a polyurethane sleeve having a rear end spacer element portion is slid onto the bridge mandrel and up against the backstop component. The front annular end surface of the sleeve lies substantially flush with the front annular end surface of the bridge mandrel.

### FIELD OF THE INVENTION

The present invention relates to a liquid applicator sleeve and an applicator assembly including such a sleeve having particular application in, and most commonly forming part of, commercial and industrial print machinery, most particularly (although not exclusively) being print machinery adapted for printing and otherwise decorating metal beverage cans, this technological field being generically referred to in the industry as metal decoration. Yet further particularly, the present invention concerns a lightweight applicator sleeve and mounting system therefor, and an assembly consisting of both the mounting system and the sleeve together, which are specifically adapted for generally unpatterned and thus uniform transfer and application of varnishes, lacquers and other coating fluids (as distinct from printing inks, which are most commonly applied in patterns).

Although the following description is provided with almost exclusive reference to metal decoration and the purpose built metal decorator machinery used therein, particularly the Concord® and Rutherford® Metal Decorators manufactured and sold by Stolle Machinery Company LLC of Centennial, Colorado, USA, the skilled reader should understand that the present invention has potentially much broader application and scope. Indeed, the skilled reader will immediately understand from the following description that the present invention may find application in any commercial or industrial printing production line or self-contained apparatus where, either before or after the application of one or more patterns of printing ink to the relevant substrate, a coating primer, varnish, or lacquer is required to be precisely uniformly and evenly and applied over a substantial proportion if not the entire substrate area to be, or which has already been, printed. Thus the present invention may apply to base coating apparatus and so-called over-varnishing apparatus alike, the only fundamental requirements of the present invention being that the relevant coating is applied in rotary manner by an essentially cylindrical applicator component, and that the coating is applied in a uniform manner, that is to say it is an unpatterned application resulting a film which substantially if not completely covers the substrate and any previous printed or otherwise inked areas thereof.

### BACKGROUND TO THE INVENTION

Metal decoration machinery has been in existence for over 50 years, and metal decoration is thus already a well established art. However, in more recent times, and as with all modern manufacturing, machinery customers, end users and consumers alike are becoming increasingly demanding as regards the quality, price, and production efficiency of the products being manufactured, and metal decoration is no exception. There is naturally a continual striving towards to achieving a superlative product at the lowest possible price point, and one particular aspect of the production of decorated metal cans of particular relevance hereto is the overall throughput in cans per minute which modern metal decoration machinery can achieve. Modern metal decoration equipment commonly now achieve can throughput rates in excess of 2000 cans per minute (CPM), and when it is considered that the cans are fed into and emerge from generally rotary decorator equipment individually, one after another, and are both printed within the decorator with an image consisting of 1, 2, 4, 6, or in some cases 8 different coloured inks, and then fully coated at least once with a varnish or lacquer, the skilled reader will immediately understand that modern metal decoration equipment can be not only complex, but must also be capable of delivering both inks and coatings with extreme accuracy and precision in a highly repeatable, consistent and reliable manner. It is with the coating side of this process with which the present invention is primarily concerned.

To provide the reader with a basic understanding of modern metal decoration equipment, most metal decorators are designed around the fundamental requirements of
receiving individual usually open-topped (i.e. closed at one end) cans in high volumes/numbers, for example delivered on a conveyor belt,
transferring each and every such can onto a (rotating) supporting mandrel wheel, each can being slid, open end first, onto one of a plurality (typically 20-30 or more) of can body pin mandrels circumferentially evenly spaced around the mandrel wheel,
printing the exterior (usually cylindrical) surface of each can by transferring a wet ink image from a blanking wheel to the can by means of mutual contacting rotation of said can and said blanking wheel, the wet ink images on the blanking plate often comprising 1, 2, 4, 6, or even possibly 8 different colour printing inks, depending on the number of active inking stations provided peripherally around the blanking wheel,
completely covering or coating the printed cylindrical surface of the can with a varnish or lacquer to stabilise the wet ink image having been immediately previously transferred to the can, so as to provide some fixing of, and/or protective coating for the wet-ink image and optionally or additionally to provide the decorated can with a lustrous quality or some other desired finish,
removing the decorated, coated cans from the mandrel for subsequent delivery to an oven to dry, and thus set the coating and printed image underneath.

Therefore, many self-contained metal decorators consist essentially of a can infeed transfer mechanism (beyond the scope of this application and not described further herein), a mandrel wheel, an ink blanket wheel surrounded by multiple inking stations, an overvarnish unit, and an outgoing can disc transfer wheel (again, beyond the scope hereof). Both the mandrel wheel and the ink blanket wheel are, in modern high-throughput decorators, generally independent large rotary sub-assembles mounted on their own frames or frameworks and adjacently disposed so that where they are most proximate one another, the ink blanket wheel kisses a single one of many identical can-carrying pin mandrels provided on the mandrel wheel (often 16, but mandrel wheels have been designed that can carry 24, or 36 cans depending on size). It is this kissing contact that, during operation, allows each one of the many identical adjacent, consecutively applied patterns of printing inks to be directly transferred to a single can as the mandrel wheel and ink blanket wheel mutually rotate (in opposite directions) relative to one another.

In some cases, the blanket wheel may be of a significantly larger diameter (often of the order of 2 m or more when 6 or 8 ink stations are provided therearound) than the mandrel wheel it serves, because the inking stations can themselves be very substantial and highly accurate pieces of equipment and are consecutively arranged around it, usually over about one third of the total circumference of the blanket wheel. Given the common requirement for the application of (usually) multiple different inks and different patterns thereof to create the final composite wet ink pattern to be applied to any individual can, and the fact that the can diameter is always very much smaller than the blanket wheel diameter, it is common for the blanket wheel to be provided with many identical complete wet ink patterns adjacent one another around its surface to increase printing capacity. Naturally, the length of the circumferential arc of any one of the 16 (or so) inked sectors that the blanket wheel is notionally divided into corresponds exactly to the total circumferential dimension of the can to be printed. Thus, at any one instant, although only one (of the many) wet ink patterns can be transferred to one can as a result of the relative rotation of the blanket wheel and mandrel wheel, driving both the blanket wheel and the mandrel wheel (carrying usually at least 16 cans at any time instant) at precisely synchronised angular velocities naturally increases the overall printing throughput at the point of contact between the two wheels in direct proportion to the diameters of the respective wheels. Finally, after any one wet ink pattern is transferred to any one can, both blanket wheel and mandrel wheel rotate further such that the now printed can moves, usually downwardly, away from the area of printing contact, and the particular previously fully wet inked area of the blanking wheel moves upwardly back towards the various inking stations positioned around the blanking wheel where that area may again be consecutively re-inked at each of said inking stations.

Turning now to the application of varnish to any can having been printed as described above, this too is effected as a result of the contacting mutual rotation between one of the many individual cans disposed on and retained by the mandrel wheel on the one hand, and a varnish applicator roll on the other. The present invention is principally concerned with this applicator roll, and the manner and means by which it is mounted in the varnish unit, commonly referred to as the over-varnish or “OV” unit, and depending on the arrangement of components thereof and the unit as a whole, sometimes the reverse over-varnish/OV unit. It should also be mentioned here that the present invention may also find application in varnish units adapted for coating continuously translating webs of material, as opposed to only cans, as will become apparent from the following description. As such, the term applicator roll assembly appearing herein, and indeed the assembly with which certain aspects of the present invention are concerned, should be understood as encompassing any and all the components which together constitute, and/or provide a mounting for the applicator roll component of an OV unit, other than the spindle or arbor within the OV unit to which the applicator roll assembly is ultimately connected and by means of which it is rotationally driven.

Traditionally, varnish applicator rolls are relatively simple mechanical items consisting of a solid steel or aluminium central hub from which radially extends a solid single continuous web of annular cross-section and which is provided with a terminal axially extending flange which is symmetrically arranged on either side of the radial web. The axial dimension of the flange (its width) is generally regarded as the critical dimension of the component, especially for metal decoration, because applicator rolls must be at least as axially deep as the cans which they are adapted to varnish, for obvious reasons. Although the solid hub-web-flange design is arguably the most common design in use today, it has been known for applicator rolls to consist most simply of a single completely solid annular billet of metal of required length, and indeed solid applicator rolls of this type are still in use. In any event, all applicator rolls, regardless of design, are always provided around their exterior cylindrical surfaces with a relatively thick (10-30 mm) solid layer of a resilient, slightly rubberised material, such as polyurethane (PU), and it is to the exterior surface of this resilient material that a thin uniform layer of liquid varnish is applied, most commonly by a gravure roll and varnish fountain adjacent thereto, immediately prior to coming into contact with any single can to be coated therewith. For the avoidance of doubt, the abbreviation PU as used herein should be interpreted as covering both polyurethane and any other material commonly or usefully employed to provide the resilient outermost surface of applicator rolls.

There are a number of problems associated with the conventional applicator rolls described above. Firstly, applicator rolls in modern metal decorators are typically of a diameter of over 400 mm, and may have diameters as great as 600 mm or even 800 mm on the highest throughput capacity machines, and therefore are inherently very heavy articles, especially when they consist essentially of a solid annular billet of metal. Applicator rolls often require replacing or exchanging, either because of progressive wear of the PU layer, or because, currently, different applicator rolls are generally designed, sized and manufactured according to the different can sizes and different coatings to be applied thereto. In short, coating taller or shorter cans which have, respectively, wider and narrower defined print widths, will generally require a deeper or shallower applicator roll.

Thus, not only does the exchange and replacement of such heavy items present health, safety and injury risks to machine operatives during changeover, but their unwieldy size and weight also gives rise to numerous mounting difficulties, particularly as regards achieving the required degree of positional accuracy within the OV unit after having been fixedly mounted therein. Furthermore, although certain OV units allow for some axial adjustment of the currently installed applicator roll so that it can be correctly and precisely axially positioned relative to the can bodies they come into contact with, in general this adjustment is also unsatisfactory for a number of reasons.

To explain further, and in the particular context of the Concord™ Decorator machines of the Stolle Machinery Company LLC, although the vast majority of the OV applicator rolls supplied with these machines have a single standardised typical diameter of 20.25 inches (514 mm), the variation in the axial widths, and also the width of the effective coating surface of the PU layer thereon, of these rolls is significant, and indeed Stolle themselves provide applicator rolls in at least 22 different widths, according to the various different can body heights that the Concord decorator machine can be adapted to print. Stolle themselves specify these as:
84.07 mm (for a “211” 8 fluid ounce/fl. oz . . . or 236 ml can, where the “211” reference specified here and in the rows below corresponds to a can diameter in inches, being the sum of the first digit, 2, and the second two digits denoting the number of sixteenths of an inch, i.e. 2× 11/16 inch; thus a 211 can has a diameter of 68.26 mm),
90.42 mm (for 211×250 ml or 202 ×150 ml cans),
97.536 mm (for 204 200 ml can),
105.664 mm (for 200×200 ml, 202×180 ml and 204×7.5 fl. oz./221.8 ml cans),
109.474 mm (for 204×8 fl. oz./236 ml or 202×185 ml cans),
114.3 mm (for 211×330 ml cans),
116.84 mm (for 204×250 ml cans),
120.65 mm (for 211×355 ml cans),
128.524 mm (for 211×375 ml cans),
132.588 mm (for 204×10 fl. oz./295 ml cans),
134.874 mm (for 202×250 ml cans),
138.176 mm (for 204×10.5 fl. oz./310.5 ml cans),
144.526 mm (for 204×330 ml cans),
147.574 mm (for 211×440 ml cans),
155.702 mm (for 211×16 fl. oz./473 ml and 204×12 fl. oz./355 ml cans),
165.1 mm for 211×500 ml and 209×450 ml cans),
180.086 mm (for 211×550 ml cans),
187.452 mm (for 211×568 ml cans),
191.516 mm (for 300×24 fl. oz./710 ml cans),
195.834 mm (for 211×20 fl. oz./591.5 ml cans),
205.486 mm (for 211 bottle), and
233.172 mm (for 204×16 fl. oz./473.2 ml bottle).

Although the Rutherford™ Decorators are somewhat more standardised in that their applicator rolls are supplied in three primary widths (5.125 in 130 mm, 7.312 in. or 185.7 mm, and 8.75 in. or 222.2 mm), the cost of manufacturing, and inconvenience, both in terms of storage and changeover, of so many different applicator rolls is significant. In practice and in production environments, given that many of the above print widths are only a few mm different, what tends to occur is that machine operatives will attempt (inadvisably and incorrectly) to utilise one applicator roll in the printing of cans of only slightly differing heights by axially adjusting the position of the entire applicator roll assembly on the drive spindle or arbor on which said assembly is mounted so that the exterior surface of the PU layer on the outside of the applicator roll assembly is correctly axially disposed relative to the exterior surface of the can body it is desired to coat. Of course, as the skilled reader will appreciate, it is essential that the print width of the applicator roll is at least the same as either the height of the can to be coated, or, where only some reduced height portion of the can body is printed, that reduced height portion. However, it is certainly possible, and indeed as is often done in practice, the print width of the applicator roll can be wider than the can body height, and in such cases it is not strictly necessary for the operative exterior surface of the PU layer of the applicator roll to be in precise registration with the cylindrical exterior surface-if the operative surface of the PU layer extends beyond the exterior cylindrical surface of the can, at one or both ends thereof while nevertheless extending fully along said can exterior cylindrical surface, then in principle, the can exterior cylindrical surface will still be properly and completely coated. However, while this approach may be preclude the need to purchase the full set of applicator rolls, it is poor compromise because this non-standard approach results in significantly higher coating liquid wastage as much more coating liquid is applied to the PU layer than is actually required, and that excess is often simply lost within the OV unit.

One of the objectives of the present invention is therefore to provide an applicator roll assembly which can be readily adapted to coat any generally cylindrically shaped receptacle, whether in can, bottle or some other form, and having a relevant height dimension within some range that usefully encompasses many of the typical can heights in current common use. As the skilled reader will immediately understand, providing only one or possibly two such applicator roll assemblies, as opposed to the 20 or more that are currently required to print all the various differently sized cans would provide numerous immediate advantages, not least in terms of overall manufacturing costs and coating liquid economies.

Returning now to the general function of applicator rolls, one of their primary functions is repeatedly and consistently deliver a precisely uniform coat weight of varnish liquid to the can over its cylindrical surface. In order to achieve this, it is critical during varnish application both that the contact pressure along the nip between the PU layer of the applicator roll and the can surface being coated is relatively constant over the axial length of said nip, and also that the relative axial orientations of the said can and said applicator roll are such that at any instant when there is contact betwixt the two, the orientation of the nip is very close to, if not exactly horizontal. Although there are commonly many adjustment mechanisms provided on the mandrel wheel, and in some cases on each of the many individual can body or so-called “pin mandrels” or can chucks thereon, and also on both the spindle or arbor on which the applicator roll is mounted and in some cases the mounting arrangement by means of which the applicator roll is secured to said spindle or arbor, it nevertheless remains difficult to achieve the desired positional mounting accuracy, and thus the constant, linearly uniform can-roll nip pressure and orientation required.

As the skilled reader will appreciate, a poorly aligned and/or positioned applicator roll can result in a wholly unacceptable progressive variation in varnish coat weight over the axial length of the can, with one end of the can body being coated with less or more varnish than the other, leading to increased rejection rates. One solution to this problem was espoused in U.S. Pat. No. 3,855,967, wherein the entire OV unit including the applicator roll is capable of being moved relative to the larger decorator machine of which it forms part, but of course this is a rather extreme not to mention costly solution. Various other solutions are proposed in U.S. Pat. Nos. 4,138,965, 4,491,613, 4,921,093, 4,271,216, 4,313,982, WO8500995, EP0134158, but these prior art documents are predominantly concerned with adjustment mechanisms, and none is specifically directed to the nature and design of the applicator roll itself.

Such disadvantages and difficulties are exacerbated in production environments when metal decorator machinery operatives have been insufficiently trained, or are relatively unskilled, or simply find it impossible to precisely mount such heavy articles correctly and accurately within the OV units. Indeed, in many instances, where increased can rejection rates are occurring during production, one solution to these types of problem is simply to adjust the applicator roll and its mounting within the OV unit so that the whole assembly is moved closer to the mandrel wheel and the can-carrying pin mandrels thereon. Naturally, this has the immediate effect of increasing the overall nip pressure between the exterior surface of the can and the exterior PU surface of the applicator roll, but this gives rise to various concomitant problems. Firstly, increasing the PU-can nip pressure, while possibly improving the uniformity of the coat weight over the can body, immediately increases the wear of the PU layer on the applicator roll, which in turn results in much reduced working life of the entire applicator roll, because once the PU layer is fully worn, the entire roll is useless and must be replaced.

A yet further disadvantage of increasing the nip pressure is that any mounting eccentricities present in the applicator roll are much exacerbated, often leading to the applicator roll “chattering”, that is oscillating and/or precessing to some degree and at some point along its axial length. As will be appreciated by the skilled reader, particularly when understanding that the applicator rolls are of a significant size and driven rotationally at many hundreds of revolutions per minute (r.p.m.) in high can throughput machines, not only does such dynamic motion often severely inhibit uniformity of application of the varnish or lacquer, but it significantly increases the mechanical stresses and strains exerted on and experienced by the underlying mounting and drive assembles, leading to more frequent mechanical failures. A yet further and costly disadvantage of these types of dynamic motion is that they lead to significant dispersion, i.e. spraying of the coating fluid inside the usually closed, self-contained OV units, leading to increased waste thereof. It should be mentioned here that the varnishes, lacquers and other coatings commonly used in OV units are a very expensive part of the metal decoration process, and conservation and efficiency of use of these fluids is of paramount importance when considering the actual cost per unit of production. To provide an example in this regard, a poorly configured and/or improperly mounted applicator roll within an OV unit can result in a coating liquid wastage of as much as 20-25%. Further objectives of the present invention are therefore the immediate mitigation of such waste, and also the reduction of the mechanical forces exerted upon the various components both within and without the OV unit without compromising, and even in some cases actually improving the uniformity of coat weight of the coating liquid over the whole length of the can body during production, while simultaneously increasing the life of applicator roll and underlying mounting and drive components of the OV unit in general.

Some of the coating inconsistencies discussed above are systematic in that all the cans coated with an incorrectly or inaccurately mounted and orientated applicator roll will be one or both of over-and under-coated to some degree, at one end of the can or another. A further possible type of coating inconsistency which can occur is more periodic in nature, and arises from the degree to which the central aperture of the applicator roll itself is eccentric with respect to the exterior, ideally (but rarely) perfectly cylindrical coating surface of the roll, being that which receives the coating liquid. As the skilled reader will understand, eccentricity of this type (measurable in place by a scalar quantity known as “total indicator reading” or TIR) will be most accentuated at the two extremes of the eccentricity, whereat the relevant applying surface of the applicator roll will be most proximate or most distant from the can surface, resulting in (at those moments) relatively thinner or thicker coat weights of varnish being applied to the can body. Again, although periodic in nature, this problem can nevertheless result in significantly higher can rejection rates, and also to the undesirable “chatter” of the applicator roll within the OV unit which, as discussed above, results in significant wastage levels of the coating fluid.

One of the primary reasons that such applicator roll eccentricities can arise is again due to the manner of mounting of the applicator roll to the spindle or arbor within the machine. As mentioned, historically it has been conventional to provide differently designed and sized applicator rolls for different applications, and in this knowledge, machine manufacturers have traditionally provided a mechanically driven expanding mandrel assembly which is directly secured to the spindle or arbor of the OV unit, and which acts to provide a universal attachment means for various different (wider/narrower or deeper/shallower) applicator rolls. Thus, when an applicator roll is desired to be changed within the OV unit, the relevant bolts of the expanding mandrel assembly are loosened, leading to a contraction of the exterior cylindrical mounting surface of the expanding mandrel, whereby a present applicator roll is released from the mandrel and can be slid axially over and away therefrom. Thereafter, a different applicator roll is selected, and slid over the mandrel in its circumferentially contracted condition towards a desired axial location determined both by the axial position that the (closed-ended) base of any can on any pin mandrel of the mandrel wheel will adopt during production, and of course the axial length of the can body to which relevant axial width of the applicator roll would, under standard operating procedures, be generally be matched. In theory of course, the expanding/contracting cylindrical mounting surface of the expanding mandrel will always be perfectly cylindrical and have its centre line or central axis perfectly coincident with the axis of rotation of the spindle or arbor of the machine on which it is mounted. In practice however, and particularly given the often harsh and aggressive physical treatments to which applicator rolls and their supporting expanding mandrel assemblies are often subjected by relatively low-skilled and/or poorly trained operatives, such perfect symmetry of mounting is very rarely achieved, and thus mounting eccentricities, sometimes significant, are almost always introduced as a result of the applicator roll mounting procedure.

Indeed, applicator roll mounting eccentricities are such a pervasive and potentially severe problem that nowadays, in practically all circumstances, a TIR measurement is always taken after the mounting of any applicator roll within the OV unit before any metal decoration commences, to assess the extent to which the rotation of the applicator roll, or more precisely the extent to which the exterior surface of the PU layer of the applicator roll, is eccentric with respect to the assumedly central axis of rotation. To provide some context in this regard, a typical TIR measurement of the order of 5-12 thousandths of an inch (127×10⁻⁶ m/127 μm to 305×10⁻⁶ m/305 μm) may be considered acceptable for the majority of applications, with a TIR of 8 thousandths of an inch (203×10⁻³ m/203 μm) being commonly quoted as a maximum in many cases.

One of the further objectives of the present invention is to substantially mitigate if not entirely preclude the various mounting and operational eccentricities, and to provide both an applicator sleeve and method of mounting thereof, as well a mounting assembly including such a sleeve, capable of achieving TIR measurements at least one order of magnitude lower than those currently achievable by existing applicator rolls and their mountings.

### SUMMARY OF THE INVENTION

According to the present invention there is provided an applicator roll assembly comprising a substantially radially symmetric lightweight metal or alloy body component comprising
a central hub portion through which an axially extending aperture is provided corresponding in diameter to that of the shaft to which the assembly is to be secured,
a peripheral axially extending flange portion to provide an essentially cylindrical exterior surface for the body component,
a radially extending web portion which extends between and unites the hub portion and the peripheral flange portion,
one or more of said portions of said body component being provided with at least one primary fluid communication conduit extending at least partially therethrough so as to be capable of directing a pressurised fluid from an interior region of said body component to an exterior region thereof,
said assembly further comprising an annular bridge mandrel component consisting essentially of a rigid plastics or plastics composite material and adapted to be secured to and completely around the body component exterior cylindrical surface, said bridge mandrel component having substantially the same axial dimension as the peripheral flange portion over which, in use, it is disposed, and being further provided with at least one fluid chamber from which radially outwardly extend a plurality of secondary fluid communication conduits angularly spaced apart around said bridge mandrel component, said fluid chamber being, in use, in fluid communication with the primary fluid communication conduit of the body component when the bridge mandrel component is secured thereto such that a pressurised fluid delivered to and through the body component is effectively circumferentially distributed around and outwardly away from an exterior cylindrical surface of said bridge mandrel component proximate one end thereof,
Characterised in that
Said bridge mandrel component is further provided, at its axially rearmost end, with an essentially annular rigid backstop component, being fixedly mounted to or integrated within the rear annular end surface of said bridge mandrel component, said backstop component having a maximum radial dimension which is greater than that of the exterior cylindrical surface of said bridge mandrel component such that some portion of said backstop component stands radially proud thereof and thus provides a raised annular shoulder against which some other component of the assembly can abut,
said applicator roll assembly further comprising
an essentially annular sleeve component consisting essentially of a polyurethane or similar resilient flexible plastics material removably mounted completely over and around said bridge mandrel component and having an exterior operative surface adapted, in use, to receive a coating liquid and having an axial dimension less than the axial dimension of the underlying bridge mandrel component, said sleeve component being disposed on said bridge mandrel such that at least a first front annular end surface thereof lies substantially flush with the corresponding front annular end surface of said bridge mandrel component,
a spacer element having an axial dimension substantially equal to:
   the total axial dimension of the exterior cylindrical surface of said bridge mandrel component minus the axial dimension of the exterior operative surface of the sleeve component,
and having a maximum radial dimension which is less than the maximum radial dimension of said exterior operative surface of said sleeve component so that the exterior surface of said spacer element is radially shallower than said exterior operative surface,
an essentially annular cap component having a maximum radial dimension which is greater than that of the exterior cylindrical surface of said bridge mandrel component such that, when removably fixedly secured to the front annular end surface of said bridge mandrel component, some portion of said cap component stands radially proud of said exterior cylindrical surface and provides a raised annular shoulder such that said sleeve component and said spacer element are effectively axially fixed in place between the raised annular shoulders of said back stop component and said cap component respectively, and

At least a pair of continuous essentially circular resilient sealing means, one being partially embedded in either of the raised annular shoulder of the backstop component or the immediately adjacent rear annular end surface of the spacer element, and one being partially embedded in either of the raised annular shoulder of the cap component or the immediately adjacent front annular end surface of the sleeve component whereby, when the spacer element and sleeve component are disposed over and around the exterior cylindrical surface of said bridge mandrel component and the cap component is secured to the front annular end surface of the bridge mandrel component, proud-standing portions of said continuous sealing means are resiliently deformed between the immediately adjacent surfaces of the raised shoulders and respective annular end surfaces of sleeve component and spacer element so that not only are said sleeve component and spacer element effectively clamped in place between the two raised annular shoulders of backstop and cap components, but the sealing means also prevent ingress of working fluid into the cylindrical interfaces defined between the exterior cylindrical surface of said bridge mandrel component and said sleeve component and said spacer element respectively.

Thus although the applicator roll assembly of the present invention effectively provides only a single axial width dimension over which a sleeve component can be slid, this dimension is ideally made wide enough to accommodate a wide range of sleeve components having axial width dimensions less than that of the exterior cylindrical surface of the underlying bridge mandrel component, so provided that a spacer element is also used of corresponding axial width dimension to make up the remainder of the total axial width dimension of said exterior cylindrical surface of the underlying bridge mandrel, said exterior cylindrical surface is effectively completely covered as would have normally been the case in prior art assemblies, but in this case, the effective operative surface of the applicator roll assembly is reduced, because said operative surface is provided only by the reduced axial width sleeve component, the spacer element being of reduced radial height as compared to the adjacent sleeve component meaning that the exterior cylindrical; surface of the spacer element plays no part in the coating process as it does not and cannot come into contact with any cans being coated within the OV unit.

Through extensive experience in the field of print and coating sleeve manufacture, Applicants herefor have realised that for any applicator roll assembly wherein some component thereof is adapted to be removable and interchangeable, for example by the conventional use of air pressure to blow, for example, a sleeve component on and off, it is essential that some preventative sealing arrangement be included whereby the ingress of typically aggressive and often chemically corrosive working fluids used in the print and coating industries be mitigated as far as possible. In this particular case, the skilled reader will of course understand that unhindered ingress of the varnishes or lacquers commonly used in OV units into and along the mating seam defined between the sleeve component and/or the spacer element on the one hand, and the exterior cylindrical surface of the bridge mandrel component on the other would, after only a relatively short period of use, render the whole assembly unusable, because such fluid ingress would eventually result in the sleeve component and/or the spacer element becoming seized to the underlying bridge mandrel. Once this occurs to any significant extent, the sleeve component can only really then be removed either by the use of destructive force, or possibly by attempting to chemically dissolve the bond formed between these respective components by the working fluid having already penetrated sufficiently to be present in relevant intervening regions. Therefore, for the present invention, Applicants have additionally devised a novel sealing arrangement whereby the cylindrical interface regions between both sleeve component and spacer element on one hand, and the exterior cylindrical; surface of the bridge mandrel on the other hand are effectively, simply but nevertheless robustly sealed off so that fluid ingress thereinto is largely if not completely eliminated. Indeed, once the front annular cap component is fixedly secured to the front annular end surface of the bridge mandrel, not only are the sleeve component and spacer element effectively secured in place, but the relevant cylindrical interface region is completely sealed as well, such sealing off occurring simultaneously with the clamping action exerted by said seals. This will become apparent from the subsequent specific description hereof provided below.

In preferred embodiments, the central aperture through the hub portion of the applicator body is provided with a keyway which receives a suitable and correspond key provided on the spindle or arbor which passes therethrough when the applicator assembly is mounted on and secured thereto.

In one embodiment of the present invention, the spacer element is a discrete and separate component from the sleeve component and in some specific embodiments said spacer element may be formed in identical fashion and constituted of identical materials and layers as the typically axially larger sleeve component. Furthermore, said spacer element may be mounted on and over the exterior cylindrical surface of the bridge mandrel component in identical fashion, for example by utilising pressurised air to assist the sliding transfer onto said exterior cylindrical surface, and possibly also, in some embodiments, to assist the sliding movement of said spacer element over said exterior cylindrical surface towards its final position adjacent the raised annular shoulder at the far end of the bridge mandrel component provided by the backstop component.

In the above embodiment, it is of course necessary to provide a further seal, because one further interface is created as a result of having two separate components, this interface being of course annular in nature and defined between the front annular end surface of the spacer element and that portion of the rear annular end surface of the sleeve component which lies adjacent thereto. Therefore in this particular embodiment, it is preferred that the applicator roll assembly includes at least one additional circular resilient sealing means, being partially embedded in either of the rear annular end surface of the sleeve component or the front annular end surface of the spacer element whereby, when the cap component is secured to the front annular end surface of the bridge mandrel component, there is additionally some resilient deformation of this additional circular resilient sealing means, which thus effectively seals this particular interface between the adjacent but physically separate sleeve component and spacer element. Most preferably, the circular resilient sealing means is provided on, and most preferably at least partially embedded within, the front annular end surface of the spacer element.

In another alternate embodiment, the spacer element is an integral part of the sleeve component and thus more an axial extension of the larger sleeve component of which it forms part. In this particular alternative embodiment, the sleeve component and spacer element portion thereof may be considered to be of unitary construction, and could, in certain embodiments, be formed by simply initially providing a sleeve component having an axial width dimension corresponding to that of the exterior cylindrical surface of the bridge mandrel component over which the sleeve component is, in use, to be disposed, and then, prior to use, machining down, for example by milling, some desired axial width portion at the rear end of the sleeve component such that the sleeve component is then provided with two distinct exterior cylindrical surface portions, a first typically axially longer exterior cylindrical surface portion which provides the effective operative surface of the sleeve component, and a second portion, of reduced radial height compared to the first portion, which may usefully be referred to as the spacer element portion. Thus in this case, the sleeve component and integrated spacer element portion thereof may, together, have an axial dimension equal to the underlying exterior cylindrical surface of the bridge mandrel component and be slid as a one-piece unit onto and thereover and into the desired axial position thereon, in which the rear annular end surface of the spacer element portion effectively abuts the raised annular shoulder of the backstop component, the intervening seal provided between these two surfaces is slightly resiliently deformed so as to create a robust seal therebetween, and the exterior cylindrical surface of the bridge mandrel component is fully and completely covered by the sleeve component and the spacer element portion thereof.

In all preferred embodiments, a yet further circular resilient sealing means is provided, being partially embedded in either of the front annular end surface of the bridge mandrel component or the rear annular end surface of the annular cap component at some radial position thereon which will overlie the annular end surface of the bridge mandrel component when the annular cap component is fixedly secured thereto, whereupon a double essentially circular continuous seal arrangement is created on either side of the vulnerable interface region between sleeve component and the exterior cylindrical surface of the underlying bridge mandrel component at the front of the applicator roll assembly. This double seal arrangement might usefully be visualised by the skilled person adopting a virtual viewing position in front of the applicator roll assembly in end-on fashion, in which the double seal arrangement, if it were not obscured by the cap component itself, would appear as two concentric circular seals, the outermost of these two being disposed radially outwardly of the vulnerable interface (which would appear in this virtual visualisation as simply a circular line), and the innermost of the two seals two being disposed radially inwardly of said vulnerable interface.

In some preferred embodiments, the backstop component is formed as an integral part of the bridge mandrel component, in which case the bridge mandrel component and the backstop component are of unitary construction with the backstop component being more a backstop portion provided at one (the rear) end of the larger bridge mandrel component. In this embodiment, both bridge mandrel component and the backstop portion thereof would thus be formed of the same material, preferably a rigid plastics, plastics composite or other similarly lightweight material, but functionally their requirements and purposes are as already described above, and further explicitly described below.

In other alternate preferred embodiments, the backstop component is a completely separate and discrete component from the bridge mandrel component, and constituted of a significantly more robust material, for example, a metal or alloy thereof. The terminology “significantly more robust” should be understood in this particular context as meaning a material having a Youngs Modulus of Elasticity (commonly denoted by letter “E” and having SI Units of N/m²) at room temperature which is at least twice that of the material of which the bridge mandrel component is substantially or entirely constituted. Most preferably, the backstop component is constituted substantially or entirely of one of: steel or some specific variety thereof, for example mild steel, Aluminium or some alloy thereof, Titanium or some alloy thereof, Nickel or some alloy thereof, a zinc alloy, and a magnesium alloy. Most preferably, the backstop component is constituted entirely of steel.

In some particularly preferred embodiments, the backstop component is provided as an initially separate and discrete component, and is constituted of metal or some alloy thereof, but is subsequently integrated into the bridge mandrel component by being cast or moulded therewith. In this particular embodiment, the backstop component would be disposed and/or fixed in the cast or mould in the desired position prior to delivery into the mould or cast of the plastics or plastics composition material of which the bridge mandrel component is constituted. After the mould or cast is then filled with the plastics or plastics composite material, and that material sets, cures, or otherwise hardens within the cast or mould, the backstop component would thus be partially but nevertheless very securely embedded within the plastics or plastics composite material at one (rear) end of the bridge mandrel component. In this particular embodiment, the cross-sectional shape of the backstop component, taken along a diametral plane of the cylindrical bridge mandrel component, is partially U-shaped, in that said backstop cross-sectional shape possesses a base web portion from which extend, at or proximate the terminal ends thereof, a pair of flange portions. Preferably the flange portions are of differing lengths, a first being less than, or of the order of one half the annular thickness of the bridge mandrel component and thus capable of being embedded entirely therewithin, and a second flange being of a length which is at least greater than one half of the annular thickness of said bridge mandrel component so that when said backstop component is embedded within the rear annular end surface of said bridge mandrel component at a radial position approximately coincident with the radial mid-point of the annular end surface of the bridge mandrel component, said second flange projects radially outwardly beyond the exterior cylindrical surface of said bridge mandrel, and thus provides a rear annular abutment shoulder therefor. In a most preferred arrangement, the embedding of the backstop component within the rear annular end surface of the bridge mandrel component is done in such a manner that the rear annular end surface of the backstop component lies flush with the exposed remaining rear annular end surface of the bridge mandrel component, which in turn lies in the same plane as all the rear annular end surfaces of the underlying body component, so that all such rear annular end surfaces lie in the same axial plane. Such an arrangement precludes any mechanical interference between the rear surfaces of the applicator roll assembly as a whole with other components within the OV unit when the applicator roll assembly is mounted therein.

In a yet further alternate embodiment, the backstop component is a discrete separate component, and is adapted to be bolted or otherwise securely removably secured to one, other or both of: a rear annular end surface of the body component, and a rear annular end surface of the bridge mandrel component. Most preferably in this embodiment, the backstop component is in the form of a substantially flat annular ring provided with a plurality of apertures therethrough to permit fixing means to pass therethrough. In this particular embodiment, it is most preferred that one or both of: the rear annular end surface of the bridge mandrel component and the radially outermost rear annular end surface of the body component are rebated back by a depth corresponding to the thickness of the backstop component so that said backstop component can be snugly received in the essentially annular rebate(s), and the plurality of apertures provided in and through the backstop component are provided with chamfers around their edges on the rear-facing side of said backstop component so that, when the backstop component is received in the rebate(s) and suitable correspondingly chamfered bolts or screws are inserted through the apertures and bolted or screwed completely into one or both of the bridge mandrel component and the body component, the rear annular end surface of the backstop component lies flush with the exposed remaining rear annular end surface of the bridge mandrel component or those remaining rear annular end surfaces of the body component which are not covered by the backstop component, so that all the rear annular end surfaces of (optionally) the bridge mandrel component, the body component and the backstop component lie in the same axial plane, which is advantageous for the reasons already described above.

Preferably, in some embodiments, the bridge mandrel has the same maximum axial width dimension as the exterior cylindrical surface of the body component, and is thus adapted to be one or both of interferingly fitted and adhesively bonded to and completely around said exterior cylindrical surface of said body component such that both front and rear annular surfaces of said bridge mandrel component lie flush with immediately adjacent front and rear annular end surfaces of said body component. If the bridge mandrel component is adhesively bonded to the exterior cylindrical surface of the body component, then preferably this is achieved using a high strength epoxy resin.

Preferably the bridge mandrel component is of laminar construction, and includes a rigid polyurethane outer layer provided on an inner layer constituted predominantly or entirely of fibreglass, or some other fibre-impregnated plastics material, such as glass fibre reinforced plastics (GFRP).

Most preferably, to increase the efficacy of the various continuous circular seals, a lubrication compound is applied to, and more preferably completely over and around the contact surfaces of said seals. A typical example of such a lubricating composition is known in the industry as “food lube” or “food lubricant”, being commonly available under the FOODLUBE™ trademark from manufacturers such as the ITW Group of Companies which trade in the UK under brandname “ROCOL”. This type of lubricant has the beneficial effects of not only of increasing the efficacy of the seals, but also of actively repelling the most commonly used varnishes, lacquers and other coating fluids used in OV units.

Most preferably, the essentially circular resilient sealing means are provided directly in backstop component and in the annular cap component, each of said components by provided with corresponding annular channels in their front-facing and rear-facing annular surfaces respectively, said channels being of a depth shallower than the circular sealing means which are thus received only partially within said channels and thus have some portion which stands proud of the respective channels in which they are received, allow said sealing means to resiliently deform substantially radially when they come into contact with, respectively, the rearmost annular end surface of the spacer element, and the frontmost annular end surface of the sleeve component. In some preferred arrangements, the seals themselves are constituted of corded or cord-reinforced rubber or resilient plastics material, such as the many different varieties of such corded seals available from Polymax Ltd, UK.

In most preferred embodiments, the annular sleeve component is multi-laminar and resilient in nature, and comprises at least a first layer being a relatively very thin (e.g. <5 mm) flexible fibreglass layer to the exterior surface of which is adhered a relatively thicker (e.g. between 8-35 mm) resilient rubberised polymer layer. Most preferably, the resilient annular sleeve component has a minimum outer diameter of at least 400 mm, and the overall construction of the sleeve is not rigid in that the sleeve would not be capable of supporting its own weight and thus adopting a generally circular or cylindrical shape, when viewed from either end, when at rest on any portion of its continuous exterior arcuate surface. As the skilled reader may appreciate, this is a quite surprising facet of the resilient annular sleeve, and the scope of this application should be considered as extending to such a sleeve in its own right, particularly as it is believed by Applicant herefor that sleeves of this type are entirely novel. It may be surprising to those skilled in the art of applicator rolls and their use that a relatively flimsy component such as is being proposed is capable of performing with sufficient accuracy and precision of coat weight delivery and varnish transfer. In this regard, Applicant has most surprisingly confirmed TIR measurements of less than 15 μm in applicator roll assemblies, including the above-described flimsy annular sleeves, manufactured in accordance with the present invention. Such low TIR measurements are wholly unprecedented for OV units and applicator rolls in general.

As to why such low TIR measurements are possible, Applicant suggests that by manufacturing the sleeve component and applicator body component, and bridge mandrel component entirely separately has numerous advantages and benefits. Firstly, separately manufacturing the sleeve component, for example on a static mandrel of appropriate diameter allows for the creation of a sleeve with more precisely cylindrical characteristics, both in terms of the lack of eccentricity of the exterior cylindrical surface with respect to the centre line/central axis of the sleeve, and also in terms of the uniformity of the annular thickness of, most critically, the resilient rubberised polymer (preferably PU or some equivalent) layer. Furthermore (in certain embodiments) effectively manufacturing, e.g. by computer numerical control (CNC) machining and drilling one, and most preferably both of the applicator body component and bridge mandrel component, the former ideally being an aluminium casting, and the latter being a plastics material casting which may then be further precision machined to required sizes and within required tolerances, means that, in similar fashion to the resilient sleeve component, perfectly cylindrical characteristics of the exterior cylindrical surface of the bridge mandrel can be much more readily achieved. Thus, when a very precisely dimensioned resilient annular sleeve is effectively “blown” onto and over a similarly perfectly cylindrical exterior surface of the bridge mandrel component, not only does the sleeve not plastically deform in any way during this relatively low stress application method, but when the sleeve is fully slid onto and over the exterior cylindrical surface and the air pressure is released, and thus becomes effectively secured to and mounted on the bridge mandrel component, it is constrained to adopt the perfectly cylindrical shape of the underlying, but substantially more solid and substantially more rigid bridge mandrel component. Finally, as previously mentioned, this perfectly cylindrical exterior surface of the completed applicator roll assembly is furthermore disposed with any eccentricities effectively minimised, and in some cases even eradicated entirely.

Thus, by the arrangement of the present invention, not only is it possible to provide a one-piece, fixed-in-place, applicator roll assembly which is very easily, quickly adaptable to enable the coating of a wide range of can body axial lengths without any need for difficult, time consuming, costly and often inaccurate re-mounting and adjustment procedures to be carried out, either on the roll assembly as a whole, or on the bridge mandrel component which forms part of it. Indeed, now, with the present invention, to change the sleeve component and spacer element, whether an integral part of the sleeve component or discrete and separate therefrom, all that is required is that
the front annular cap component be unscrewed and removed,
a source of pressurised air be applied to the applicator roll assembly in order that the sleeve component can be slightly radially expanded and thus loosened from and around the exterior cylindrical surface of the bridge mandrel assembly and thus easily manually slid off therefrom,
(optionally, if the spacer element is a discrete separate component), sliding removal of the spacer element in similar fashion to the sleeve component, and replacement with a larger or smaller spacer element, as required,
A replacement sleeve component having a desired effective operative surface axial width be slid onto and over the exterior cylindrical surface of the bridge mandrel component, with the source of pressurised still applied to assist the fitting and sliding actions,
The source of pressurised air be removed, whereupon the sleeve component becomes effectively and very securely interferingly fitted and secured in place on and around the exterior cylindrical surface of the bridge mandrel component,
Re-affixing the front annular cap component to the front of the assembly.

One particular reason that an applicator roll assembly of the present invention can usefully be employed is worth further explanation. In many, indeed most modern metal decorator machines, the base level or zero axial datum is determined by the axially front-most edge of the pin mandrels onto and over which the open-topped can bodies are, in, in use slid. As the skilled reader will appreciate, the can bodies are closed-ended only at one end, and they are printed and coated in this condition. Therefore the can bodies can only be slid open-end first over the pin mandrels until their closed-end bases or some circumferentially narrower part thereof comes into abutting contact with the front-most edge of the pin-mandrels, which thus automatically arrests any further axial travel of the can bodies on the pin mandrels. The final axial position of the can bodies on the pin mandrels is thus solely determined by the abutting contact between the base of the can and the end of the pin mandrel over which the can body is disposed. Thus while the axial position of the base of the can body, and thus the base of the exterior cylindrical surface thereof to be printed and/or coated, is generally fixed, prior to this invention, not only was it generally always required to select and mount an applicator roll assembly matched to that of the axial length of the can body to be printed/coated, but it was also often required to further adjust the mounting of any such applicator roll by so-called “jacking in” or “jacking out” the applicator roll so that the effective operative coating surface of the applicator roll was in exact axial registration with that cylindrical portion of the can body to be coated (note here that in many instances, only some axial portion of the entire axial length of the cylindrical exterior surfaces of the can bodies may require printing and/or coating).

Although these repeated mounting and jacking procedures could ultimately achieve axial registration of applicator roll and can body print width, they are extremely mechanically onerous, both on the machinery and on human individuals, and have the ultimate effect of increasing rotation and mounting eccentricities, often to unacceptable levels, which would mean either using a new applicator roll, or repeating the mounting procedure until the eccentricities could be reduced to acceptable levels. As the skilled reader will appreciate this is massively inefficient as compared to the procedure now required, and wherein mounting and rotational eccentricities are largely automatically minimized. Specifically, in the present invention, the vast majority of the applicator roll assembly only requires accurately mounting once, whereafter only the sleeve and spacer elements are swapped, depending on the can bodies to be printed, so applicator roll mounting eccentricities are effectively permanently minimised, from the first and only mounting operation.

Also, for the reasons that will be become apparent from the further description provided below, the much reduced annular thickness of the sleeve component, the nature of its construction, and the fact that the essentially fixed bridge mandrel component can be manufactured extremely accurately so that its exterior cylindrical surface is essentially precisely centred on the central axis of rotation of the applicator roll body as a whole means that applicator rolls having exceedingly low TIR values, after mounting, are now possible.

A specific embodiment of the invention is now described by way of example and with reference to the accompanying drawings wherein.

### BRIEF DESCRIPTION OF THE DRAWINGS

FIG. 1 shows a schematic outline of the major components of a conventional metal decorator machine,

FIG. 2 shows a perspective schematic view of a Stolle™ reverse overvarnish (OV) unit, and the various essential major components arranged therein,

FIGS. 3A, 3B, 3C, 4A, 4B, 4C show respectively front elevation, sectional and enlarged detail views of two conventional, prior art applicator roll assemblies of narrow (FIGS. 3A, 3B, 3C) and wide (FIGS. 4A, 4B, 4C) configuration, of the type available from the Stolle™ Machinery Company,

FIGS. 5A, 5B show respectively a front, end-on elevation and sectional view on A-A of a body component casting of the present invention,

FIGS. 6A, 6B show respectively a sectional view taken on a centre line (or diametral plane) of a spacer element of the present invention, and an enlarged detail view thereof,

FIG. 7 shows a sectional view taken on a centre line of a sleeve component of the present invention,

FIGS. 8A, 8B show respectively a sectional view along a centre line of a backstop component of the present invention, and an enlarged detail view of one portion of that sectional view showing the arrangement wherein a circular resilient seal is provided therein,

FIGS. 9A, 9B, 9C show respectively a front elevation, a sectional view taken on a centre line, and an enlarged detail view of one front edge of a cast or moulded bridge mandrel component of the present invention with the backstop component of FIG. 8 already integrated within and partially embedded in a rear surface thereof,

FIGS. 10A, 10B show respectively a sectional view taken on a centre line and an enlarged detail view front annular cap component of the present invention,

FIGS. 11A, 11B show, respectively, a front elevation and a sectional view taken on a centre line of the applicator roll assembly of the present invention in a fully assembled condition, and ready for mounting within an OV unit, and

FIG. 12 shows a perspective view of a polyurethane sleeve for use in the present invention, and forming an independent aspect thereof.

### DETAILED DESCRIPTION

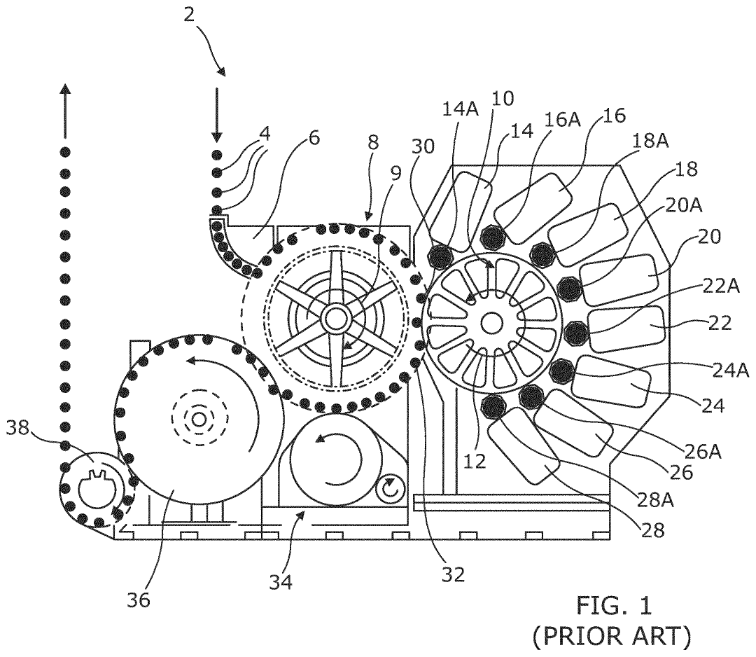

Referring firstly to FIG. 1, a conventional Concord™ metal decorator machine 2, of the type generally available from the Stolle Machinery Company is schematically depicted. Open topped can bodies 4, illustrated in the Figure simply as black dots given their end-on representation in the Figure, are fed individually (at usually very high infeed rates, e.g. many hundreds or even thousands of cans per minute “CPM”) into a can infeed and transfer mechanism 6 whereby each can is transferred to one of the many individual mandrels provided around a mandrel wheel 8. Said mandrel wheel in this case is provided with 32 individual mandrels, each of which is capable of individual mechanical actuation (e.g. expansion and contraction to grip and release the interior of the can body), and each of which is individually resiliently mounted on the mandrel wheel, for example using some form of spring biased mounting mechanism such that each mandrel and thus the can body thereon is biased towards the outer reaches of the mandrel wheel and adopts a position such that a most radially remote portion of any can body lies approximately coincident the circular periphery of the mandrel wheel itself. In the machine shown, mandrel wheel 8 is configured to rotate in a clockwise direction as shown by arrow 9, progressively bringing each mandrel and can body thereon into direct contact with an ink blanket wheel 10, which is naturally driven in the opposite anticlockwise direction, as shown at arrow 12. Around the outside of ink blanket wheel 12 are arranged 8 individual, distinct and separate inking stations 14, 16, 18, 20, 22, 24, 26, 28, each being provided with a respective ink transfer roll 14A, 16A, 18A, 20A, 22A, 24A, 26A, 28A which effectively transfers each of the 8 possible different patterns of different inks consecutively to each of the (in this case) 12 areas of the exterior cylindrical surface of the ink blanket wheel designated to receive the wet ink patterns, so that what results on each of said areas after any one has been rotated under the ink transfer rolls of all the ink stations is a complete, composite wet ink image which, as a result of the further rotation of the ink blanket wheel is brought into contact with the exterior cylindrical surface of a can body, in the instant illustrated in the Figure, at nip point 30. As a result of the contact between the ink blanket wheel and the can body, the underlying mandrel supporting the can is deflected inwardly of the mandrel wheel against the spring bias, and while it is contact therewith, the can body naturally rotates on the mandrel as a result of both the contact pressure between can body and ink blanket wheel, and the relative and opposite motions of the ink blanket wheel and the mandrel wheel.

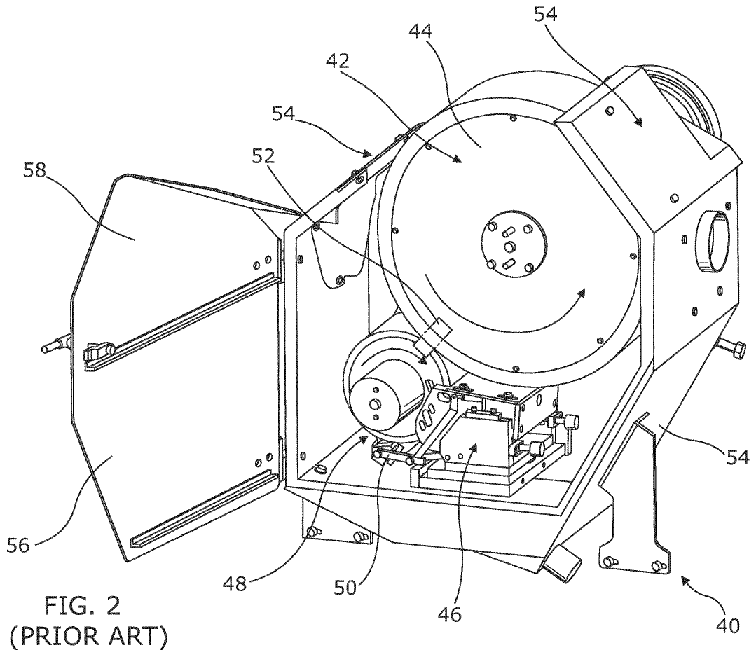

After the wet ink composite image has been completely transferred in this manner, the can body emerges from the contact area in fully printed state, and in the instant depicted in the Figure, such a printed can is referenced at 32. Continued clockwise rotation of the mandrel wheel then causes each printed can body to enter a varnishing unit indicated generally at 34 and described in greater detail below with reference to FIG. 2. In essence, the varnishing unit transfers a thin, uniform, unpatterned layer of varnish over the entirety of the printed exterior of the can body, thus effectively encapsulating the printed image beneath the varnish, before subsequent transfer rolls 36, 38, lift the can bodies from the mandrel and transport them away to, for example, and oven or similar varnish curing facility (not shown) before the completed open-topped can bodies are then collected for packaging.

As the skilled reader might may appreciate from the foregoing, there is an additional requirement, within the metal decorator itself, for extremely precise registration of the various component parts of the machinery-in short, all the various component parts of the machine must work completely in unison and in precise registration with one another for successful decoration and varnish coating of any one individual can. Therefore, not only are the various different rotary and reciprocating components within the decorator often mechanically geared or otherwise linked together, there are numerous static and dynamic operation characteristics of practically all of the major components of the machinery which can be minutely adjusted to ensure that each and every can received by and exiting from the machine is properly printed, coated, and otherwise decorated.

Referring now to FIG. 2, there is shown a varnish unit indicated generally at 40 consisting essentially of an applicator roll 42 which in use, rotates adjacent the mandrel wheel (not shown) so that can bodies supported on the individual mandrels provided on the mandrel wheel rotate, firstly, into initial contact with the applicator roll, then secondly around the mandrel that supports them as a result of the mutual relative and opposite rotation of the respective mandrel wheel and applicator roll, whereby a layer of varnish is transferred from the applicator roll to the whole of can body exterior surface (and no more and no less, i.e. there is no overlap or shortfall of varnish application), and then thereafter as the mandrel wheel rotates further, the can body and supporting mandrel move out of contact with the applicator roll.

As can be seen in FIG. 2, the applicator roll 42 comprises an essentially solid cylindrical body 44 around which is provided a reasonably thick (e.g. 10-35 mm) layer of a durable, resilient polymer such as polyurethane, usefully characterised as having a measurement of between 35-60 Durometer Shore (Hardness) “A”. Other components commonly present in varnishing units such as that illustrated, and not forming part of the present invention, are a varnish fountain unit 46, a (usually) laser engraved Gravure roll 48 against which a doctor blade 50 apparatus acts to remove excess varnish, lacquer or other coating fluid from the gravure roll so that an essentially even and laterally uniform coat weight of varnish is transferred from the gravure roll to the applicator roll when the two come into mutual contact in a contact area generally referenced in dotted outline at 52. Again, as with ink blanket wheel and mandrel wheel, the gravure roll and applicator roll rotate in opposite directions, with the direction of both such rotations being dictated by the direction of rotation of the mandrel wheel. Finally, the entire varnish unit 40 is commonly encased within a steel enclosure 54 and accessed through a front door 58.

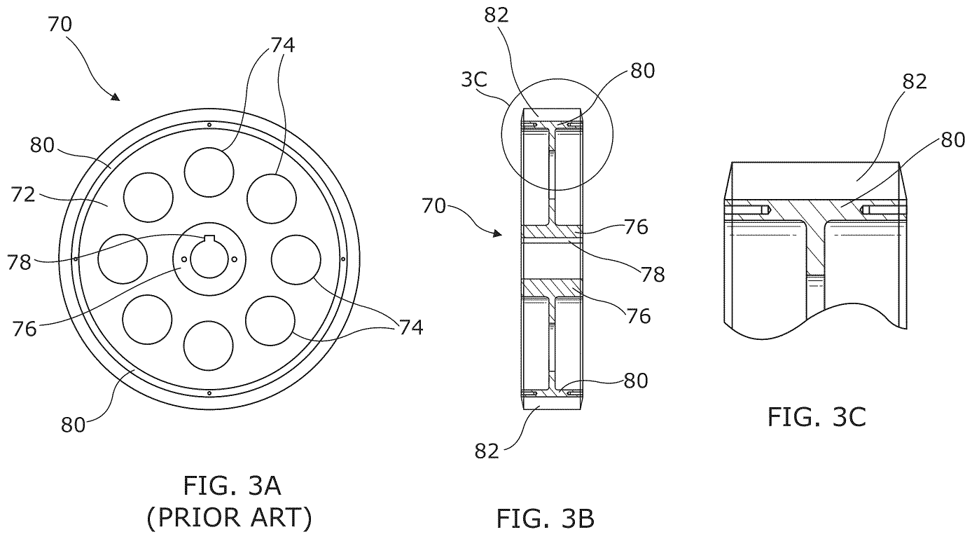

Referring briefly now to FIGS. 3A, 3B, there is shown an applicator roll 70 in front elevational and sectional views respectively, with FIG. 3C showing an enlarged detail of the exterior cylindrical surface of the applicator roll body with rubberised polymeric covering thereon. In the particular embodiment illustrated here, applicator roll 70 includes a body 72 which is substantially perforated with large identical apertures 74 arranged in perfectly symmetrical arrangement so as to maintain the rotational inertial balance of the roll body, such apertures naturally being provided to reduce the overall weight of the roll body. In the embodiment shown the roll body has a diameter of apprx. 600 mm and a width (see FIG. 3B) of apprx. 120 mm suitable for varnishing conventional the smaller, 330 ml can bodies. It is to be noted here that a solid Aluminium cylinder of this diameter would weigh apprx. 90 kg, which would require at least two human male adults to lift, and of course the power requirements for driving, or at least accelerating, decelerating and otherwise modulating the angular velocity of such an applicator roll would also be very considerable, so the skilled reader can immediately appreciate why it is so important that the weight of applicator roll bodies be reduced as much as possible without compromising their structural rigidity and rotational inertial balance characteristics.

Centrally provided within the applicator roll body is an integrally formed hub 76 provided internally with a keyway 78 whereby the roll body can be mounted on, and correctly angularly positioned relative to the spindle or arbor of the varnish unit which ultimately rotationally drives the applicator roll. The roll body is additionally provided with a continuous peripheral flange 80, again integrally formed with other parts of the roll body, which is thus a preferably of unitary or one-piece construction. Around the exterior surface of the peripheral flange portion 80 is provided a continuous layer of an ideally slightly rubberised, resilient polymer such as polyurethane of (critically, as regards the uniform application of varnish to can bodies) uniform thickness.

FIGS. 4A, 4B show an applicator roll 90 essentially similar to that of FIGS. 3A, 3B, with FIG. 4C showing an enlarged detail view of the roll 90 similar to that of FIG. 3C for the roll 70, the only difference being the diametral and axial (flange width or depth) dimensions, which in the case of FIGS. 4A, 4B, 4C are: a total outer diameter of apprx. 510 mm, with an axial dimension of 175 mm (suitable for larger 500 ml, 550 ml, 600 ml can bodies, and possibly larger). It is to be noted that in both FIGS. 3C and 4C, the actual operative “working face” dimension is marginally less than the overall axial depth/width of the applicator body and flange thereon, by an amount of perhaps 1-5%, due to the tendency of the polymeric material to deform elastically when disposed around the exterior cylindrical surface of the flange, typically under slight tension.

The applicator rolls 70, 90 are most preferably cast in moulds, but they may also be machined from more substantial cylindrical solid billets of Aluminium. In either event, the applicator roll bodies may preferably subjected to some surface finishing treatment, and the body as a whole may also be hard anodised. It should be mentioned here that although Aluminium is the most preferred metal, it is certainly possibly that other similarly lightweight, structurally and physically robust metals or alloys may be used.

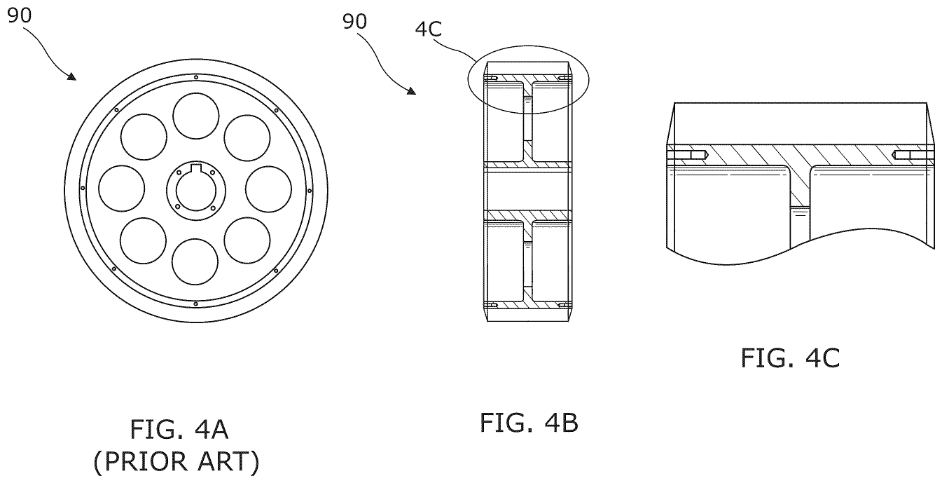

Referring now to FIGS. 5A, 5B, there is shown a body component of the present invention indicated generally at 100, being ideally cast, moulded or being a machined component of unitary construction and fabricated ideally in Aluminium or some other similarly lightweight, structurally and physically robust metal or alloy thereof. The body component comprises a precisely centrally disposed hub portion 102, a plurality of web portions 104 angularly symmetrically arranged around and extending radially away from said hub portion, and a continuous peripheral flange portion 106 which is united with the hub portion be means of said web portions. In the embodiment illustrated, the peripheral flange portion 106 is provided with a single drilled and internally tapped aperture 107 therethrough by means of which a pressurised air hose connection valve (not shown) may be screwingly affixed on the hub-facing side of said peripheral flange.

It is to be mentioned here that the provision of aperture 107 is one particularly preferred means whereby a source of pressurised air can be effectively delivered through the body component from some interior region to some exterior region thereof. As the skilled may understand, it is somewhat essential that the means of pressurised air delivery is fully contained inside the body component, and does not project axially in any way from either end thereof, as an axially projecting component could potentially be quite dangerous, especially when the applicator roll assembly is rotating at relatively high speed during use. Of course, other internal pressurised air delivery arrangements may be contemplated, such as providing a single continuous conduit within one or more of the otherwise solid portions of the body component, said conduit possibly extending, for example, from an annular and surface of the hub and subsequently axially through the hub to it's axial mid point, whereat said conduit could proceed radially through one or more of the radial web portions, and then radially further through the peripheral flange portion, ultimately opening into the exterior cylindrical surface thereof. In such an arrangement, it would thus be possible to adapt the applicator roll assembly mounting within the OV unit to be provided with a corresponding conduit, and if the mounting of the applicator roll assembly were correctly mounted thereto, with the respective conduits of each in registration, then not only could a source of pressurised air be delivered directly to the applicator roll assembly by the OV unit, this could be achieved without any need for manual intervention on the part of machine operatives. Indeed, it is possible that such an arrangement could facilitate some degree of automation in the sleeve changeover process. This possibility is, however, mentioned here only to illustrate the fact that the particular means by which a source of pressurised air be connected and/or connectable to the body component (and in turn, the bridge mandrel component) is not particularly relevant to the present invention. In contrast, what is important is (ultimately) that some pressurised air or other fluid be capable of being delivered to the exterior cylindrical surface of the bridge mandrel component, proximate one or other end thereof, in a largely circumferentially evenly distributed manner.

Returning now to the body component 100, the manufacture of this component must be precise so that the exterior cylindrical surface 108 provided by said peripheral flange portion 106 is perfect cylindrical, with practically zero eccentricity relative to the central axis of the hub component for reasons already described above. Furthermore, the radial distance of the exterior cylindrical surface 108 from the central axis of the body component must be uniform across the entire axial length of the body component, and also around its entire circumference, as will be understood by those skilled in the art. To provide some context as regards dimensions for one particular body component according to the present invention, the maximum outer diameter of the body component, being that of the exterior cylindrical surface thereof, may be 423.8 mm, with an axial length of 212 mm. The inner diameter of the peripheral flange portion, at the front or operator side thereof, whereat the aperture 107 is provided immediately behind the front edge thereof, may be 385 mm, giving an annular thickness of a front annular end surface 108A of 19.4 mm.

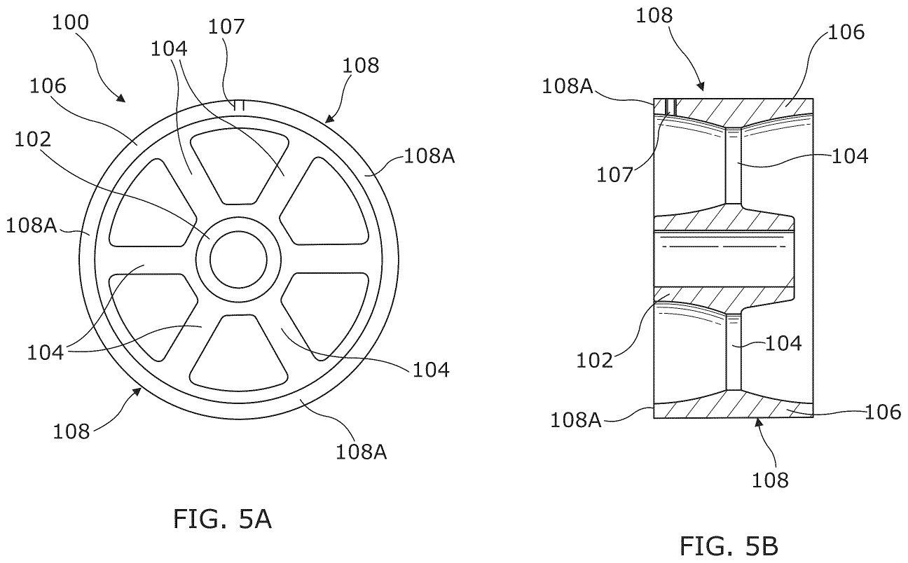

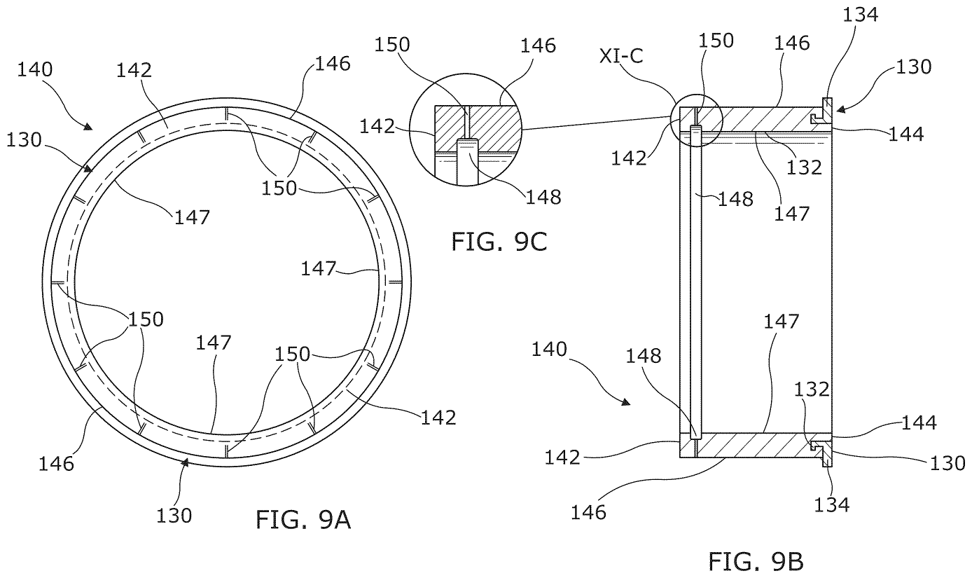

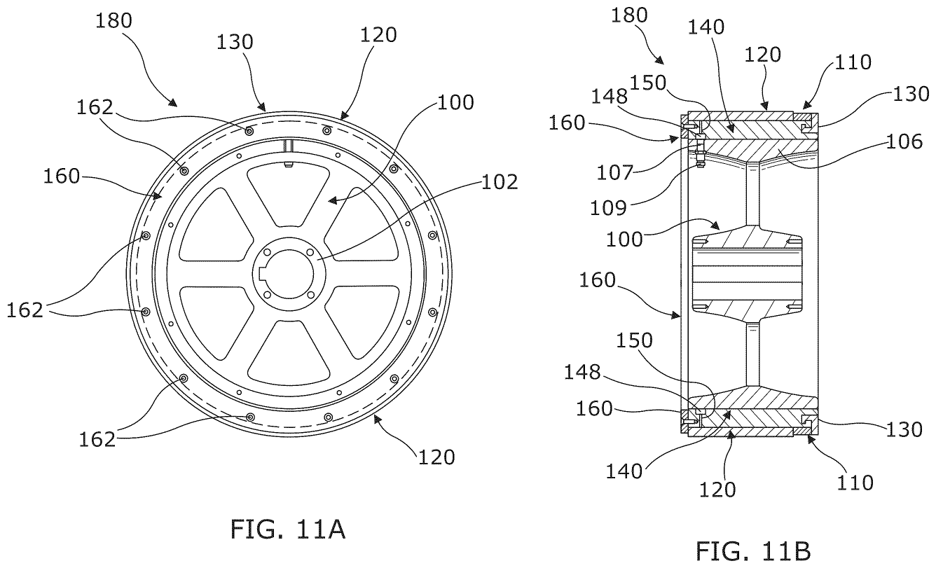

Turning now to FIGS. 6A, 6B, there is shown a spacer element indicated generally at 110 being in the form of a continuous band of, in this particular embodiment, stainless steel. Of course, as the skilled person will immediately understand, the spacer element illustrated is a separate and discrete component and as will be described fully below with reference to FIGS. 9A, 9B, 9C and 11A, 11B, adapted to be slid over the exterior cylindrical surface of the bridge mandrel component, in accordance with one specific embodiment of the present invention. In terms of the specific embodiment of the present invention being herein described and illustration, the axial width dimension of the spacer element is 29 mm, its outer diameter is 505 mm and its inner diameter is 481.35 mm, giving an annular thickness of the spacer element of 11.825 mm. The base axial width dimension of the spacer element (not including the seal) is 29 mm.

As can be seen clearly in FIG. 6B, the spacer element has a front annular end surface 112 and a rear annular end surface 114, and is provided, in its front annular end surface with a continuous partially embedded seal 116. In the preferred arrangement illustrated, an annular channel having a width generally corresponding to that of the seal 116 is machined in the front annular end surface 112 of the spacer element, and the seal, is fully and completely inserted therein. In some embodiments, the seal may be adhesively bonded within the annular channel so provided so that its retained therein. Finally, the depth of the annular channel is such that some portion of the seal stands proud of the channel and thus also the adjacent portions of the annular end surface 112 which said seal now radially partitions. In this arrangement of course, a component of the applicator roll assembly adjacently disposed to said annular surface would first come into contact with the proud standing portion of the seal and a seal is thus created between said component and the spacer element, as prescribed in specific embodiments of the present invention.

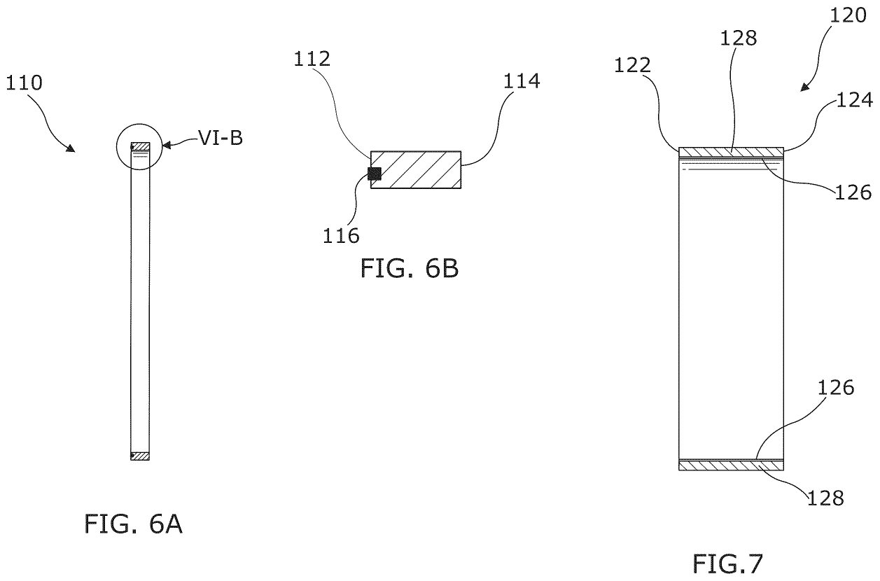

Turning now to FIG. 7, there is shown a sleeve component indicated generally at 120, which in this illustrated embodiment with squared off end surfaces, being a front annular end surface 122 and a rear annular end surface 124, though of course given the symmetry of the illustrated sleeve component, it is of course axially reversible. The construction of the sleeve component is preferably laminar, consisting essentially of a first inner layer 126 of fibre glass or similar fibre reinforced plastics or other material, which is completely covered by an outer layer 128 of a resilient polyurethane or polyurethane composite material. Dimensionally, in this embodiment, the outer diameter of the sleeve component is 514.35 mm, the inner diameter is 481.35 mm (note here this is identical to the corresponding dimension of the spacer element, because, as the skilled reader will appreciate, both components are ultimately to be disposed adjacent one another on and around one and the same bridge mandrel component as further described below with reference to FIGS. 11A, 11B), giving a total annular thickness of 16.5 mm (note here also that this is greater than the annular thickness of the spacer element, so when adjacently positioned therewith on the bridge mandrel component, the sleeve stands proud of the spacer, as is a most preferred feature of the present invention). In this particular embodiment, the axial width dimension of the sleeve component is 165.5 mm, which would be ideally matched to the abovementioned Stolle™ can body specifications of “211”×500 ml and “209”×450 ml.

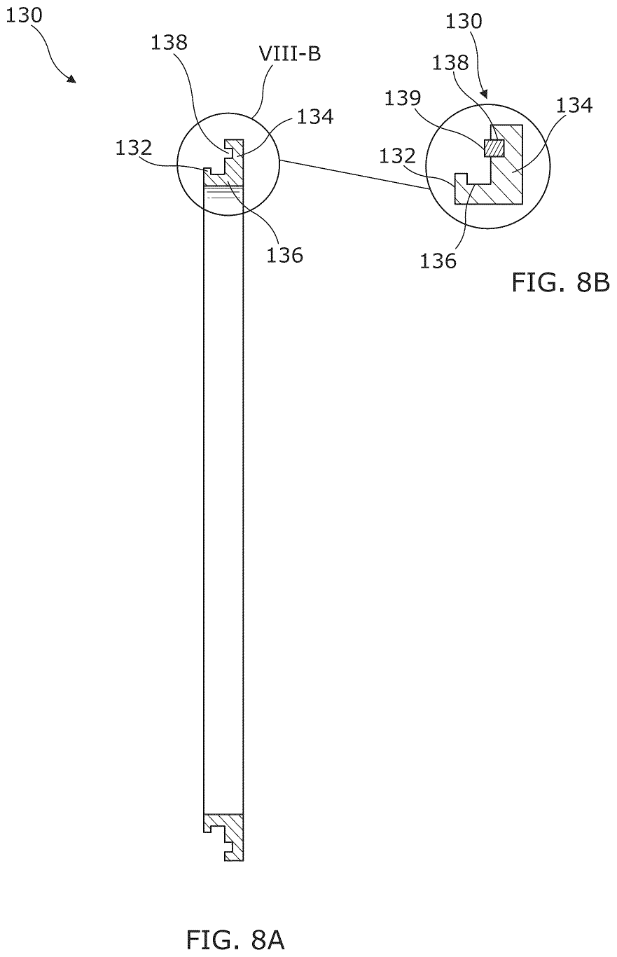

Referring now to FIGS. 8A, 8B, a backstop component, indicated generally at 130, and takes the form of a generally annular component and having a cross-sectional shape, axially, which is generally U-shaped wherein a radially shorter, front flange portion 132 and a radially longer rear flange portion 134 extend radially away and upwardly from a bridging base web portion 136. In the illustrated embodiment, the (uniform) inner diameter of the backstop component is 445 mm, the maximum diameter dimension of the shorter flange portion is 470 mm, and the maximum diameter dimension of the shorter flange portion is 510 mm. The total axial width of the component is 28 mm, with axial width dimensions of shorter and longer flange portions being, respectively, 5 mm, and 13 mm, leaving an intervening axial gap therebetween of 10 mm. Again, the requirements as regards the various dimensions of this component, in particular relative to the bridge mandrel component will become apparent from the further description provided below in relation to FIGS. 9A, 9B, 9C, 11A, 11B. In most preferred embodiments, the backstop component is constituted of steel, e.g. varieties thereof well known to those skilled in the art and commonly specified as “304” or “304L”, or some other similarly structurally and physically robust metal or alloy thereof.

Within a front facing surface of the flange portion 134 there is provided a square or rectangular channel 138 formation which may be machined in said surface, and in similar fashion to the channel provided in the spacer element and described above with reference to FIGS. 6A, 6B, the width of said channel formation 138 generally corresponds to that of a seal 139 of suitable corresponding width to be inserted therein. Again, as for spacer element 110 above, the axial thickness or depth of the seal will be greater than that of the channel formation into which it is inserted such that there remains, after full insertion, some portion of the seal which stands proud and clear of the adjacent surface of said flange portion 134. In some embodiments, the seal may be adhesively bonded within the annular channel formation so provided so that it is retained therein. In the completed arrangement, and as is the case with the spacer element, when the seal, which is of course circular and continuous and inserted completely into correspondingly continuous and circular channel formation 138, a component of the applicator roll assembly adjacently disposed to the front facing surface of said flange portion 134 annular surface would first come into contact with the proud standing portion of the seal and an effective seal is thus created between said component and the backstop component by virtue of said contact with the seal, as prescribed in specific embodiments of the present invention, and further described below.

As with other dimensions of the backstop component, the specific radial position of the channel formation, and thus the seal are important, not in terms of exact measurement, but the radial position relative to the maximum outer diameter of the bridge mandrel component of which the backstop component will ultimately form part. In particular, the radial position of the mid point of the channel formation must be greater than the maximum outer diameter dimension of the bridge mandrel component by a distance at least equal to, and preferably greater than one half the radial width of the channel formation, (i.e. the width of the opening of the channel, measured radially) so that the entire channel formation and the seal ultimately received therein lie beyond that maximum outer dimension of the bridge mandrel component, specifically being that diametral dimension of the exterior cylindrical surface of said bridge mandrel component. In the specific embodiment illustration, the radially measure mid-point of the channel formation 138 lies at a radial position of 488.75 mm, and the channel width (and thus that of the seal ideally received therein) is 3.5 mm. The axial depth of the channel formation is, the specific embodiment illustrated, 3 mm.

Turning now to FIGS. 9A, 9B, 9C, there is illustrated in these Figures a bridge mandrel component according to the invention and indicated generally at 140. This component is most preferably constituted of rigid polyurethane or composite polyurethane material. The use of the term “rigid” in this context is to be contrasted with the use of the term “resilient” as regards the polyurethane material of which the sleeve component is substantially constituted, because there is some considerable difference in the physical properties of the bridge mandrel component, which is preferably a rigid, very much self-supporting structure, as compared with the sleeve component which as will become apparent from the further description provided below, need not be nearly so rigid, and indeed the sleeve component may be a comparatively and relatively flimsy component. Persons skilled in the art will be aware that there are a wide variety of polyurethane and polyurethane composite materials with similarly varying degrees of structural robustness and rigidity, and appropriate selection of such for use in these particular respective components is not something that is considered to be a specific feature of the invention, excepting that there should be some significant, non-negligible difference in the physical properties of the polyurethane material selected for the bridge mandrel component as compared to that selected for the sleeve component.

It can be seen from these particular FIGS. 9A, 9B, 9C that the bridge mandrel component is also a generally annular in form, but preferably its axial width dimensions is substantially equal, indeed most preferably identical to that of the body component of FIGS. 5A, 5B and over the exterior cylindrical surface of which said bridge mandrel component is adapted to be mounted. Specifically, bridge mandrel component 140 has a front, operator-side annular end surface 142, a rear or machine-side annular end surface 144 (“machine-side” here referring to the innermost region of OV unit in which the applicator roll assembly of the present invention is adapted to be used), and an exterior cylindrical surface 146, which is, to the maximum extent possible utilising modern manufacturing techniques, perfectly cylindrical with respect to the central axis of the component and entirely devoid of eccentricities with respect thereto. For the purposes of this description, the interior cylindrical surface, similarly as perfectly cylindrical as the exterior for reasons that will become apparent, is also referenced at 147.

As can also be seen from the Figures, particularly FIG. 9B, the bridge mandrel component is shown having already had backstop component 130 embedded within its rear end surface in such a manner that the rear annular end surface of flange portion 134 of the backstop component 130 lies radially flush with the rear annular end surface 144 of the bridge mandrel component. As can also be seen in FIG. 9B specifically, the shorter length flange portion 132 of backstop component 130 is completely embedded within the body of the bridge mandrel component, the result being that said backstop component is not only firmly and securely retained within and by the surrounding material of the bridge mandrel component, but also the longer flange portion 134 stands radially proud of the immediately adjacent exterior cylindrical surface 146 of the bridge mandrel component, and thus provides a rear abutment shoulder therefor to thus provide a backstop which prevents other components of the applicator roll assembly from passing beyond.

Immediately behind the front annular end surface 142 of the bridge mandrel component, there is provided a rebate or channel 148 machined out of the interior cylindrical surface 147 to some desired depth, typically less than 50% of the total annular thickness of the bridge mandrel component.

In the particular illustrated embodiment, the inner diameter of the bridge mandrel component is 424 mm, the outer diameter of the exterior cylindrical surface 146 is 487 mm, the maximum out diameter of the longer flange 134 of the integrated embedded backstop component 130 is 515 mm. These dimensions given a total annular thickness of the bridge mandrel component of 31.5 mm, and the channel or rebate 148 extends radially beyond the interior cylindrical surface 147 by a distance of 8 mm, which of course equates to the radial depth of said channel or rebate. The total axial width of the bridge mandrel component is 212 mm, which as the reader will note, is exactly the same as the axial width of the body component over which said bridge mandrel component is adapted to be disposed and on and to which is intended, in use, to be securely mounted and affixed.

In and around said channel or rebate 148, at angularly equally spaced intervals, there are provided a plurality of air conduits 150, typically of a diameter of 3 mm or thereabouts and more clearly illustrated in FIG. 9A (in which the equally spaced arrangement can be seen), and in 9C. As will become apparent from the further description provided below, the channel and air conduits act together, when substantially closed off when the bridge mandrel component is properly mounted on the underlying body component, to provide an air distribution chamber around which pressurised air can be communicated and delivered, through the equally angularly spaced conduits to a front portion of the exterior cylindrical surface of the bridge mandrel component, so that the sleeve component (primarily at least) can be initially mounted on, and then relatively more easily slid along said bridge mandrel component exterior cylindrical surface, either towards its rear end when mounting a new sleeve component, or in the reverse direction when a currently mounted sleeve component is desired to be removed and replaced.

Again, as mentioned briefly above in connection with the body component with reference to FIGS. 5A, 5B, the provision of channel 148 and air conduits 150, while providing a useful means of circumferentially and evenly distributing pressurised air around the exterior cylindrical surface of the bridge mandrel component proximate one end thereof, is only one particular configuration of the bridge mandrel component whereby such a distribution may be achieved. The skilled person could of course devise other arrangements, and the present invention should not be considered limited by the specific configuration illustrated and described. To reiterate, the exact manner and means whereby pressurised air can be delivered in this manner is not of fundamental importance to the present invention, but the fact that there are some means which can achieve such delivery and distribution most certainly is.

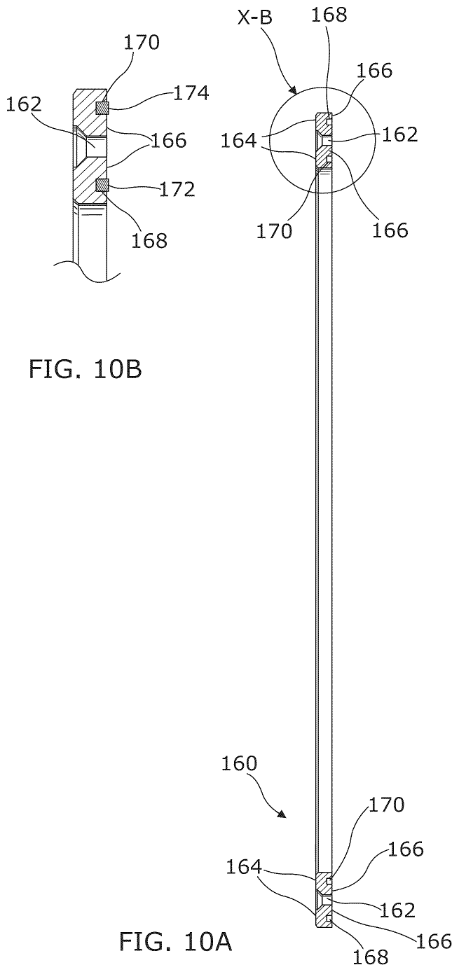

Referring now briefly to FIGS. 10A, 10B, there is shown a generally annular cap component indicated generally at 160 provided with at least 2 screw apertures 162 arranged diametrically opposite one another (or, where more than two are provided, the arrangement of the apertures should be perfectly angularly evenly spaced, and where an even number of apertures is provided, their arrangement should be symmetrical about some diameter). The cap component has a annular front end surface 164, and an annular rear end surface 166, and as can be seen in both FIG. 10A, and particularly in 10B, front portions of said apertures 162 are chamfered to receive correspondingly chamfered screws so that a flush mounting arrangement can be achieved.

As may also be seen in both FIG. 10A, and particularly in 10B, the rear annular end surface 166 of the cap component is provided with two channels, concentrically disposed, one 168 radially to the inside of the apertures 162 and another 170 disposed radially to the outside of said apertures. Said channels may be machined out of the rear annular end surface and may have a depth typically less than 50% of the total axial width dimension of the cap component. With particular reference to FIG. 10B, said channels 168 170 are each provided with a single continuous circular seal 172, 174 respectively, of broadly identical specification, arrangement and configuration to that provided in the spacer element and described above in relation to FIGS. 6A, 6B. In particular, said seals 172, 174 are of a cross-sectional size and shape broadly corresponding to the dimensions of the channels 168, 170 into which they are received, except that some portion of said seal stands prouds of the rear annular end surface 166 of the cap component so that when the cap component is screwed in place onto the front end of the applicator roll assembly, the seals can resiliently deform slightly and thus provide an effective seal against respective portions of said applicator roll assembly with which they come into contact.

Again, the dimensions of the cap component may be regarded as somewhat important, for reasons that will become apparent from the further description provided below, and in this particular embodiment, the total axial width of the cap component is 10 mm, its maximum outer diameter is 500 mm, and its inner diameter is 430 mm. Although these specific dimensions (as with all other component dimensions) will be prone to change depending on specific application and configuration of the OV unit, as well as (possibly) various other parameters, it is important to note here that the outer and inner diameter dimensions, and more specifically the radial positions of the channels 168, 170 are most preferably carefully selected with reference to the maximum outer diameter of the bridge mandrel component (or, alternatively the inner diameter of the sleeve component, which upon mounting of the latter on the former, should be effectively identical). In particular, it is most preferred that
the radial dimension of the inner channel (and thus the resulting inner seal) is less than the corresponding radial dimension of the exterior cylindrical surface of the mandrel so that the resulting seal lies radially inwardly of the interface formed between the exterior cylindrical surface of the bridge mandrel and the overlying sleeve component once mounted thereon and therearound, and
the radial dimension of the outer channel (and thus the resulting outer seal) is greater than the corresponding radial dimension of the exterior cylindrical surface of the mandrel so that the resulting seal lies radially outwardly of the interface referred to above,
   the overall result that the said interface is effectively “sealed off”, and fluid ingress thereinto, at a front, operator side of the applicator roll assembly, is almost if not totally precluded by said seals. As for the spacer element and backstop component described above and illustrated in FIGS. 6A, 6B and 8A, 8B respectively, the axial depth of the seal-receiving channels is 3 mm, and their radially measure widths are each 3.5 mm.

Turning now to FIGS. 11A, 11B, there is shown a fully assembled applicator roll assembly according to the present invention is indicated generally at 180, this assembly being in a condition in which it would be when mounted within an OV unit of a metal decoration machine ready for production. In this Figure, the various components and portions thereof previously referenced and described in earlier FIGS. 5A, 5B, 6A, 6B, 7, 8A, 8B, 9A, 9B, 9C, 10A, 10B are referenced in this Figure with like reference numerals. Previously unreferenced features present in FIGS. 11A, 11B are provided with new reference numerals.

The order of assembly of roll 180 is as follows. Firstly, after a layer of epoxy or similar high strength adhesive is applied to one or both of the exterior cylindrical surface of the body component and the interior cylindrical surface of the bridge mandrel component, the bridge mandrel component 140, complete with already integrated and embedded backstop component 130 is slid over the exterior cylindrical surface of the body component until respective front and rear annular end surfaces of both components lie are flush with one another, as clearly illustrated in FIG. 11B. In this position, the partially completed assembly is allowed to rest for a suitable period of time to allow the adhesive to cure and set firm. Note from FIG. 11B the relative axial positions of the aperture 107 provided through peripheral flange portion 106 of the body component, and the rebated channel 148 provided in the inner cylindrical surface of the bridge mandrel component they are substantially coincident, so that when a source of pressurised air is connected to a valve 109 screwed into aperture 107, that air is distributed internally within and circumferentially completely around said rebated channel, before subsequently passing through the various air radially extending air conduits 150 which extend from the base of said rebated channel, into and through said bridge mandrel component and which open into the exterior cylindrical surface thereof.

Once the bridge mandrel component is secured in place on the body component, and possibly after removal of any adhesive from the front and rear annular end surfaces of the resulting partially completed assembly, such possibly having escaped from the interface region between respective adjacent cylindrical surfaces of bridge mandrel component and the underlying body component as a result of the sliding fitting of the former to the latter, the spacer element is slid over the exterior cylindrical surface of the bridge mandrel in the correct axial orientation, i.e. with its rear annular end surface, being that not provided with any seal, towards and into generally abutting relationship with that portion of the longer flange of the backstop component which projects radially upwardly from the adjacent exterior cylindrical surface of the bridge mandrel component and provides a generally annular abutment shoulder therefor. The axial travel of the spacer element is of course halted when its rear planar annular end surface comes into contact with that portion of the seal provided in the backstop component which axially projects from the front surface of said flange portion. Ideally, the inner diameter dimension of the spacer component is marginally greater than that of the outer diameter dimensions of the exterior cylindrical surface of the bridge mandrel component so that the spacer element can be relatively easily and manually slid along the said surface. In some instances, the initial outer diameter dimension of the exterior cylindrical surface of the bridge mandrel is chosen to be marginally greater than that of the inner diameter dimension of the spacer element, so that the exterior cylindrical surface of the bridge mandrel can be surface ground or otherwise machined down to the desired diameter and the surface finish thereof can thus be improved.

Once the spacer element is in position on an around the rearmost portion of the exterior cylindrical surface of the bridge mandrel component, the sleeve component is then provided initially around the front edge of the bridge mandrel exterior cylindrical surface, and with a source of pressurised air having been applied to the valve 109 provided on the body component. It is to be noted here that this source of pressurised air may be connected during sliding mounting and fitting of the spacer element described above, to assist the mounting and fitting thereof. The use of pressurised in air in this case pneumatically assists the mounting of the rear end of the sleeve on and over the front end of the bridge mandrel component as the pressurised air serves to radially expand the sleeve slightly and thus render it manually easier to subsequently slide the remaining portion of the sleeve over the exterior cylindrical surface of the bridge mandrel component. The axial sliding motion of the sleeve component is completed when its rear annular end surface comes into abutting and slightly compressing relationship with the seal which projects axially from the front annular surface of the already fitted spacer element.

Once spacer element and sleeve component have been slid onto and over the exterior cylindrical surface of the bridge mandrel component in the manner described above, and at this stage most likely only manually, there may be some small (maybe only of the order of 1-2 mm) portion of the sleeve component left axially overhanging the front annular end surface of the bridge mandrel component. To complete the assembly, and slightly axially compress together the sleeve component, the seal provided in the front annular end surface of the spacer element, and the seal provided in the front-facing surface of the longer flange portion of the backstop component, and of course the spacer element also, the annular cap component is then screwed onto the front of the assembly, specifically onto the front annular end surface of the bridge mandrel component. Although this operation may not exert very high compression on the spacer element and sleeve component now lying in intervening relation between the cap component on one hand and the backstop component on the other, the use of mechanical means to fix the cap component nevertheless does allow for some greater compressing force to be applied than could be manually achieved, and furthermore this mechanically applied compression force also tends to further axially align the various intervening components, in particular so that the front annular end surface of the sleeve component lies flush with the front annular end surface of the underlying bridge mandrel component. Yet further, this mechanical compression force naturally and simultaneously causes further compression of the various seals, which of course tends to increase the efficacy of those seals and render them largely if not completely impregnable to working fluids. Thus an effectively well sealed arrangement is provided between all of: the front annual cap component, the sleeve component, the spacer element, the backstop component, and the bridge mandrel component, so that fluid ingress into the vulnerable interface region defined between respective adjacent cylindrical surfaces of sleeve component, spacer element and bridge mandrel component is effectively precluded, while simultaneously providing an applicator roll assembly which is significantly more versatile than any prior art applicator roll, and which can readily and easily be adapted for the coating of a wide range of different can body lengths.

As can be seen in the FIGS. 11A, 11B, the completed assembly is shown with annular cap component 160 fixed in place after mechanical fixing thereof, as described above, has been completed. From FIG. 11A, it can be seen that annular cap component 160 is provided with 12 equally angularly spaced apart (by 30 degrees) fixing apertures, some of which are referenced in the FIG. 11A at 162. Suitable screws (not referenced), preferably chamfered as previously described, are used to achieve this and these are screwed directly into correspondingly spaced apart drilled and tapped screw holes (not referenced).

Once the assembly is in its completed condition as illustrated, it is to be noted that the exterior cylindrical surface of the sleeve component 120 is not only of a reduced axial width as compared to the axial width of the underlying bridge mandrel component, and therefore has an effective operative surface which is of similarly reduced axial width, but also that the exterior cylindrical surface of the sleeve component 120 stands radially proud of the immediately adjacent spacer element 110, which therefore does not contribute at all to the coating performed by the applicator roll assembly. One or both of these are, in some aspects, preferred features of the present invention. Furthermore, it should be mentioned also that the majority of the above description of assembly, in particular the fitting (and subsequent removal and replacement) would most commonly be performed after the partially assembled applicator roll assembly, comprising only the body component and bridge mandrel component mounted on and secured thereto, had already been mounted within the OV unit of larger metal decorator machinery. As previously mentioned, it is much easier, simpler, and less onerous on shop floor operatives to replace only spacer elements and sleeve components, as compared to the current practice which involves highly onerous, difficult sometimes dangerous (certainly from the point of view of health and safety) removal and replacement of entire applicator roll assemblies whenever a can body of different axial length is desired to be coated.

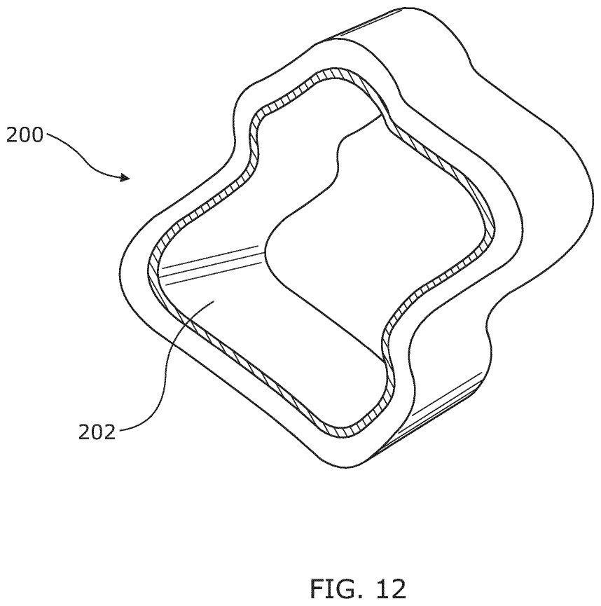

Finally, referring to FIG. 12, there is shown a perspective view of a flexible polymeric sleeve indicated generally at 200, suitable for use with the present invention, and forming an independent aspect of the present invention in its own right. The sleeve is continuous and comprises a first continuous inner, relatively thin layer 202 of between 1-5 mm in thickness, and being constituted of a flexible, essentially resinous fibre-glass material, or other similar fibre-reinforced material being both flexible and primarily constituted of an essentially fibrous base material precursor. By continuous is meant that the layer is essentially free from any joining seam, and indeed is not manufactured by means of overlapping giving rise to any type of seam jointing: the layer is continuous, such as would be the case with a circular extrusion, or where a former was dipped into a viscous liquid composition which was then allowed to set and cure, and could optionally be built up over time by repeating such a process. The skilled reader will be aware of other seamless manufacturing techniques.

Around the entirety of the inner fibreglass layer, which by its very nature readily accepts and strongly binds with a wide variety of adhesives, is adhesively secured a relatively much thicker (e.g. 8 mm-35-40 mm) layer 154 of a rubberised polymeric compound such as polyurethane. Again, as with the underlying fibreglass layer, the polymeric layer is continuous and seam-free, and thus together, the sleeve is of relatively robust construction, and although over time it may of course become worn, it should not ultimately ever tear, which given the very high rotational speeds of operation, could of course have very serious consequences.

As to the relevant dimensions of the sleeve itself, these will of course be carefully selected according to (a) the outer diameter of the exterior cylindrical surface of the underlying bridge mandrel component over and around which the sleeve is ultimately intended to be disposed, and (b) the axial length of the can bodies which any particular sleeve component is to coat. That is to say, the sleeve component axial length, or at least that of the effective operative surface thereof will be exactly matched to a specific can body axial length. Most preferably, the sleeve component will have an internal diameter which is of the order of 0.5-3% less than the corresponding outer diameter of the applicator roll in order that when the sleeve is fully “blown” onto the bridge mandrel component as further described below, and the air pressure is removed, the sleeve becomes interferingly fitted to the bridge mandrel exterior cylindrical surface as it both radially contracts around it, which simultaneously gives rise to tensile hoop stress around it and within the sleeve.

Most surprisingly to Applicant and its customers, sleeves manufactured as provided above are not only capable of being manufactured to exceedingly high specifications and tolerances, as is essential considering the applications for which the sleeve is adapted, but also that such sleeves are incapable of supporting their own weight, and thus appear (as in FIG. 7) somewhat flimsy and thus of non-circular cross-sectional shape prior to fitting onto the applicator roll body component.

As the skilled reader may appreciate, in order to apply the sleeve 150 to the bridge mandrel, such having already been affixed within an OV unit, all that is required is a source of pressurised air, which is connected to the relevant air valve provided on the body component, after which the flexible sleeve may be initially draped over the vertically topmost or zenith surface of the bridge mandrel component before the operative can manually radially expand the remainder of the sleeve so that its remote, rear side edge is forced up onto and over said bridge mandrel. Of course, there does not need to be any significant axial motion of the sleeve onto the bridge mandrel component before the rear edge of the sleeve overtops the air conduits provided circumferentially around the bridge mandrel component, which naturally cause the sleeve to radially expand slightly, thus significantly easing the sliding motion of the remainder the sleeve which has not yet been slid thereonto and thereover.

Once this has occurred, and the rearmost edge of the sleeve then comes into abutting relationship with the front annular end surface of the spacer element, or more specifically with the front-most annular surface of the seal provided therein. Ideally the sleeve component is manually pushed into an axial position on the bridge mandrel where its frontmost annular end surface lies flush with other annular end surfaces of the bridge mandrel and the applicator roll body, in which position the sleeve is properly and fully fitted, and the pressurised air source is simply removed, whereupon the sleeve becomes effectively firmly secured to and around the exterior cylindrical surface of the bridge mandrel over which it is disposed.

1. An applicator roll assembly comprising a substantially radially symmetric lightweight metal or alloy body component including a hollow central hub portion, a peripheral axially extending flange portion providing an essentially cylindrical exterior surface and a radially extending web portion which extends between and unites the hub portion and the peripheral flange portion, one or more of said portions of said body component being provided with at least one primary fluid communication conduit extending at least partially therethrough so as to be capable of directing a pressurized fluid from an interior region of said body component to an exterior region thereof,
said assembly further comprising an annular bridge mandrel component consisting essentially of a rigid plastics or plastics composite material adapted to be secured to and completely around the body component exterior cylindrical surface, said bridge mandrel component having substantially the same axial dimension as the peripheral flange portion over which it is disposed, and being further provided with at least one fluid chamber from which radially outwardly extend a plurality of secondary fluid communication conduits angularly spaced apart around said bridge mandrel component, said fluid chamber being, in use, in fluid communication with the primary fluid communication conduit of the body component when the bridge mandrel component is secured thereto,
wherein:
Said-said bridge mandrel component is further provided, at its axially rearmost end, with an essentially annular rigid backstop component which stands radially proud of the exterior cylindrical surface of said bridge mandrel component and thus provides a raised annular shoulder against which some other component of the assembly can abut,
said applicator roll assembly further comprising:
an annular sleeve component consisting predominantly of a resilient flexible plastics material and which provides an operative exterior cylindrical surface to and from which a coating liquid can be applied and transferred respectively, said sleeve component being disposed on and completely around said bridge mandrel such that at least a first front annular end surface thereof lies substantially flush with the corresponding front annular end surface of said bridge mandrel component,
a spacer element having an axial dimension substantially equal to:
the total axial dimension of the exterior cylindrical surface of said bridge mandrel component minus the axial dimension of the exterior operative surface of the sleeve component,
and having a maximum radial dimension which is less than the maximum radial dimension of said exterior operative surface of said sleeve component,
an essentially annular cap component having a maximum radial dimension which is greater than that of the exterior cylindrical surface of said bridge mandrel component such that, when removably fixedly secured to the front annular end surface of said bridge mandrel component, some portion of said cap component stands radially proud of said exterior cylindrical surface and provides a raised annular shoulder such that said sleeve component and said spacer element are effectively axially fixed in place between the raised annular shoulders of said back stop component and said cap component respectively.

2. An applicator roll assembly according to claim 1, further comprising at least a pair of continuous essentially circular resilient sealing means, one being partially embedded in one of:
the raised annular shoulder of the backstop component, and the immediately adjacent rear annular end surface of the spacer element,
and one being partially embedded in one of:
the raised annular shoulder of the cap component, and the immediately adjacent front annular end surface of the sleeve component
whereby, when the spacer element and sleeve component are disposed over and around the exterior cylindrical surface of said bridge mandrel component and the cap component is secured to the front annular end surface of the bridge mandrel component, proud-standing portions of said continuous sealing means are resiliently deformed between the immediately adjacent surfaces of the raised shoulders, and respective annular end surfaces of sleeve component and spacer element.

3. An applicator roll assembly according to claim 2, wherein the spacer element is a discrete and separate component from the sleeve component.

4. An applicator roll assembly according to claim 3, further comprising a third continuous essentially circular resilient sealing means, being partially embedded in one or other of the adjacent annular end surfaces of the sleeve component and the spacer element, said sealing means thus providing a seal between those two surfaces within their interfacial region.

5. An applicator roll assembly according to claim 2, wherein the spacer element is an integral part of the sleeve component but of reduced radial dimension compared to the remainder of said sleeve component such that said sleeve component is provided with two distinct exterior cylindrical surface portions, a first axially longer exterior cylindrical surface portion which provides the effective operative surface of the sleeve component, and a second spacer element portion.

6. An applicator roll assembly according to claim 2, wherein a further circular resilient sealing means is provided, and is partially embedded in one of:
the front annular end surface of the bridge mandrel component and the rear annular end surface of the annular cap component at some radial position thereon which will overlie the annular end surface of the bridge mandrel component when the annular cap component is fixedly secured thereto, thus creating a double essentially circular continuous seal arrangement is created on either side of the vulnerable interface region between sleeve component and the exterior cylindrical surface of the underlying bridge mandrel component at the front of the applicator roll assembly.

7. An applicator roll assembly according to claim 2, wherein the backstop component is:
formed an integral part of the bridge mandrel component, and of the same material,
an initially completely separate and discrete component from the bridge mandrel component but integrated into that component during casting or moulding molding, and is of a different material which is twice as strong as that of which the bridge mandrel is predominantly constituted,
a discrete separate component, and is adapted to be bolted to one, other or both of: a rear annular end surface of the body component, and a rear annular end surface of the bridge mandrel component.

8. An applicator roll assembly according to claim 2, wherein the backstop component is an initially separate component which is subsequently integrated into or bolted to bridge mandrel, and the cross-sectional shape of said backstop component, taken along a diametral plane of the cylindrical bridge mandrel component, is partially U-shaped, in that said backstop cross-sectional shape possesses a base web portion from which extend, at or proximate the terminal ends thereof, a pair of flange portions.

9. An applicator roll assembly according to claim 8, wherein the flange portions of the backstop component are of differing lengths, a first being less than, or of the order of one half the annular thickness of the bridge mandrel component and thus capable of being embedded entirely therewithin, and a second flange being of a length which is at least greater than one half of the annular thickness of said bridge mandrel component so that when said backstop component is embedded within the rear annular end surface of said bridge mandrel component at a radial position approximately coincident with the radial mid-point of the annular end surface of the bridge mandrel component, said second flange projects radially outwardly beyond the exterior cylindrical surface of said bridge mandrel, and thus provides a rear annular abutment shoulder therefor.

10. An applicator roll assembly according to claim 9, wherein the rear annular end surface of the backstop component lies flush with the exposed remaining rear annular end surface of the bridge mandrel component, which in turn lies in the same plane as all the rear annular end surfaces of the underlying body component, so that all such rear annular end surfaces lie in the same axial plane.

11. An applicator roll assembly according to claim 1, wherein the bridge mandrel has the same maximum axial width dimension as the exterior cylindrical surface of the body component, and is one or both of:
interferingly fitted and adhesively bonded,
to and completely around said exterior cylindrical surface of said body component such that both front and rear annular surfaces of said bridge mandrel component lie flush with immediately adjacent front and rear annular end surfaces of said body component.

12. An applicator roll assembly according to claim 1, wherein the bridge mandrel component is of laminar construction, and includes a rigid polyurethane outer layer provided on an inner layer constituted predominantly or entirely of one or more of:
fibreglass, a fibre-impregnated plastics material, and glass fibre reinforced plastics (GFRP).

13. An applicator roll assembly according to claim 2, wherein a lubrication compound is applied over and around the contact surfaces of one or more of the continuous essentially circular resilient sealing means.

14. An applicator roll assembly according to claim 2, wherein one of the pair essentially circular resilient sealing means is provided directly in backstop component and one is provided in the annular cap component, each of said seals being partially embedded therein such that some portion of said seal stands proud of the surface in which it is partially embedded.

15. An applicator roll according to claim 2, wherein one or more of the essentially circular resilient sealing means is constituted of corded or cord-reinforced rubber or resilient plastics material.

16. An applicator roll assembly according to claim 1, wherein the annular sleeve component is of multi-laminar construction, and comprises at least a first fibreglass layer to the exterior surface of which is adhered a relatively significantly thicker resilient rubberized polymer layer.

17. An applicator roll assembly according to claim 1, wherein the spacer element is a discrete and separate component from the sleeve component.

18. An applicator roll assembly according to claim 1, wherein the spacer element is an integral part of the sleeve component but of reduced radial dimension compared to the remainder of said sleeve component such that said sleeve component is provided with two distinct exterior cylindrical surface portions, a first axially longer exterior cylindrical surface portion which provides the effective operative surface of the sleeve component, and a second spacer element portion.

19. An applicator roll assembly according to claim 1, wherein the backstop component is:
formed an integral part of the bridge mandrel component, and of the same material,
an initially completely separate and discrete component from the bridge mandrel component but integrated into that component during casting or molding, and is of a different material which is twice as strong as that of which the bridge mandrel is predominantly constituted,
a discrete separate component, and is adapted to be bolted to one, other or both of: a rear annular end surface of the body component, and a rear annular end surface of the bridge mandrel component.

20. An applicator roll assembly according to claim 1, wherein the backstop component is an initially separate component which is subsequently integrated into or bolted to bridge mandrel, and the cross-sectional shape of said backstop component, taken along a diametral plane of the cylindrical bridge mandrel component, is partially U-shaped, in that said backstop cross-sectional shape possesses a base web portion from which extend, at or proximate the terminal ends thereof, a pair of flange portions.
